(19) United States
(12) Patent Application Publication
(10) Pub. No.: US 2026/0189613 A1
(43) Pub. Date: Jul. 2, 2026

(54) SYSTEMS AND METHODS FOR COORDINATING MULTIPLE CONCURRENT INTERACTIVE APPLICATIONS WITH UNIFIED SESSION MANAGEMENT AND DYNAMIC ENGINE LIFECYCLE CONTROL

(71) Applicant: Jason Bramble, Orlando, FL (US)

(72) Inventor: Jason Bramble, Orlando, FL (US)

(21) Appl. No.: 19/410,736

(22) Filed: Dec. 5, 2025

Related U.S. Application Data
(60) Provisional application No. 63/739,625, filed on Dec. 29, 2024.

(51) Int. Cl. H04L 65/1083

(52) U.S. Cl. CPC H04L 65/1083

(57) ABSTRACT

A computer-implemented system coordinates multiple concurrent interactive applications via a central communication router maintaining sessions identified by session identifiers and application identifiers. The router directs messages between client devices without interpreting content. A session management module generates session identifiers paired with application identifiers. An onboarding module produces machine-readable codes enabling participants to join by scanning codes. An engine instantiation module creates engine instances executing application logic within isolated environments. A lifecycle management module suspends instances when inactive, saves states through serialization, and restores instances by deserializing saved states when devices reconnect. Client devices are assigned roles including host console, heads-up display, or controller. A shared service layer provides artificial intelligence integration, globalization, localization, and authentication accessible to all sessions. This unified architecture enables multiple distinct applications to operate concurrently under shared infrastructure without requiring separate backend systems for each application.

### CROSS-REFERENCE TO RELATED APPLICATIONS

The present application claims priority to U.S. Provisional Application No. 63/739,625 filed Dec. 29, 2024, titled “GAME-AGNOSTIC MULTI-SESSION ARCHITECTURE,” which is hereby incorporated by reference in its entirety.

### TECHNICAL FIELD

The embodiments generally relate to the technical field of computer-based session management and communication systems for multiplayer interactive applications.

### BACKGROUND

Conventional multiplayer and social gaming systems are designed to facilitate hosting and coordination of interactive experiences between multiple participants over network connections. Such systems often operate as standalone platforms dedicated to specific game types or application categories.

These systems typically support the storage and organization of game states, player profiles, and session records. Many employ dedicated server architectures where each game or application maintains its own backend infrastructure, communications layer, and data management resources. When service providers wish to offer multiple games, each application generally requires separate development of server logic, client interfaces, and network communication protocols.

Conventional solutions may also generate analytics or reporting features summarizing player engagement and system performance. These features are often implemented independently for each application, requiring separate maintenance and monitoring processes. In many cases, session management within these systems is application-specific and relies on hard-coded logic tailored to particular game mechanics or interaction patterns.

While such systems provide functionality for hosting interactive applications, they face challenges in supporting multiple distinct applications under unified infrastructure, maintaining consistent onboarding experiences across different application types, or managing computational resources efficiently when hosting numerous concurrent sessions. Game logic is typically embedded directly into communication layers, making it difficult to add new applications without substantial redevelopment. Player onboarding processes often require application-specific downloads, separate authentication flows for each game, or manual entry of session codes rather than streamlined joining mechanisms. Additionally, server resources are commonly allocated statically to specific applications rather than being dynamically managed based on actual session activity.

Consequently, there is a need for an improved session management system that addresses the limitations of application-specific architectures, reduces redundant development across multiple games, and provides enhanced integration between session coordination, player onboarding, and resource management workflows.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, the disclosed system, method, or software product may include a central communication router configured to maintain a plurality of application sessions concurrently. The router may identify each application session via a session identifier and an application identifier, enabling the router to direct messages between client devices without requiring knowledge of application-specific logic.

In one aspect, embodiments may include a session management module configured to generate the session identifier for each application session and pair the session identifier with the application identifier. The module may maintain session identifier registries that enable accurate message routing to correct application sessions.

In one aspect, embodiments may include an onboarding module configured to produce machine-readable codes encoding session identifiers and network endpoints. The module may enable participants to join application sessions by scanning the machine-readable codes, which direct client devices to registration interfaces where users enter information to join sessions.

In one aspect, embodiments may include an engine instantiation module configured to create and initialize engine instances for application sessions requiring server-side processing. The module may execute application-specific logic within isolated execution environments separate from other engine instances, enabling multiple distinct applications to operate concurrently without cross-interference.

In one aspect, embodiments may include a lifecycle management module configured to manage engine instances by suspending them when session activity indicates inactivity and restoring them when client devices reconnect. The module may save current states of engine instances to persistent storage during suspension and load saved states during restoration, enabling seamless continuity while conserving computational resources.

In one aspect, embodiments may include a shared service layer configured to provide standardized capabilities comprising artificial intelligence integration, globalization functionality, localization functionality, and authentication services. The layer may make these capabilities accessible to all application sessions via a common interface, enabling new applications to automatically inherit platform capabilities without requiring additional integration.

In some aspects, the system may include at least one computing device in operable communication with a network and a server in operable communication with the network to host a multi-session platform containing the above-described modules. The computing device may execute instructions to perform the operations described herein, thereby enabling unified, scalable coordination of multiple concurrent interactive applications that previously required separate backend infrastructures.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 is a flow diagram illustrating an exemplary operational sequence of the Session Management Module, according to some embodiments;

FIG. 4 is a flow diagram illustrating an exemplary operational sequence of the Onboarding Module, according to some embodiments;

FIG. 5 is a flow diagram illustrating an exemplary operational sequence of the Central Communication Router, according to some embodiments;

FIG. 6 is a flow diagram illustrating an exemplary operational sequence of the Lifecycle Management Module, according to some embodiments;

FIG. 7 is a flow diagram illustrating an exemplary operational sequence of the Engine Instantiation Module, according to some embodiments;

FIG. 8 is a flow diagram illustrating an exemplary operational sequence of the Shared Service Layer, according to some embodiments; and

FIG. 9 is a flow diagram illustrating an exemplary end-to-end system operational flow, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed system may include at least one computing device in operable communication with a network and a server configured to host and execute a multi-session platform. The multi-session platform may include multiple functional modules, each implemented in software, firmware, hardware, or any combination thereof. In some embodiments, the modules may include a Central Communication Router configured to maintain a plurality of application sessions concurrently and to direct messages to correct application sessions via session identifiers and application identifiers without interpreting message content. A Session Management Module may generate session identifiers for application sessions and pair each session identifier with an application identifier that identifies the type of interactive application being hosted. An Onboarding Module may produce machine-readable codes encoding session identifiers and network endpoints to enable participants to join application sessions by scanning the codes with client devices. An Engine Instantiation Module may create and initialize engine instances that execute application-specific logic within isolated execution environments separate from other engine instances. A Lifecycle Management Module may manage engine instances by suspending them when session activity indicates inactivity, saving current states to persistent storage through serialization, and restoring engine instances by loading saved states when client devices reconnect. A Shared Service Layer may provide standardized capabilities comprising artificial intelligence integration, globalization functionality, localization functionality, and authentication services that are accessible to all application sessions via common interfaces. A Communication Module may establish and maintain network communication channels with client devices. A Database Engine may manage structured data storage and retrieval operations for the Data Repository and Engine State Storage.

Conventional multiplayer gaming platforms often process session requests in an application-specific manner, with limited ability to coordinate multiple distinct applications under unified infrastructure or manage computational resources dynamically across diverse interactive experiences. The disclosed embodiments address this problem by combining session-based message routing with dynamic engine lifecycle management and shared service integration to enable multiple distinct interactive applications to operate concurrently under a single communication framework. This configuration enables unified, scalable session management that can coordinate diverse application types without requiring separate backend infrastructure for each application while maintaining isolation between concurrent sessions and conserving computational resources through intelligent engine suspension and restoration.

In practice and in use, the system may be deployed by an organization that operates multiple multiplayer interactive applications such as trivia games, bingo games, quiz competitions, or other social gaming experiences across multiple venues or host locations. When a host user requests creation of an application session for a selected interactive application, the Session Management Module may generate a session identifier and pair it with an application identifier corresponding to the selected application type. The Onboarding Module may produce a machine-readable code encoding the session identifier, which is transmitted to a heads-up display device for presentation. When participants scan the machine-readable code with controller devices, the Central Communication Router may establish network communication channels, assign client roles to the connected devices, and begin routing messages to the correct application session based on the session identifier. If the application identifier indicates that server-side processing is required, the Engine Instantiation Module may create an engine instance that executes application-specific logic within an isolated execution environment. As the application session progresses, the Central Communication Router coordinates message transmission between the host console device, heads-up display device, controller devices, and engine instance according to assigned client roles. When session activity indicates that no client devices remain connected, the Lifecycle Management Module may suspend the engine instance by saving its current state to persistent storage through serialization, thereby conserving computational resources. When client devices subsequently reconnect to the application session, the Lifecycle Management Module may restore the engine instance by loading the saved state from persistent storage and deserializing it back into an operational state, enabling seamless continuity of the application session without requiring participants to restart or lose progress.

In this way, the system may improve operational efficiency by enabling multiple distinct applications to share common infrastructure for session coordination, participant onboarding, and resource management rather than requiring separate backend systems for each application. The dynamic lifecycle management eliminates the need to maintain continuously running processes for inactive sessions while ensuring that session states are preserved for seamless restoration when activity resumes. The unified onboarding mechanism provides consistent participant joining experiences across different application types through machine-readable code scanning rather than requiring application-specific authentication flows or manual entry of session codes. The session-based message routing prevents cross-session interference by ensuring that messages containing one session identifier cannot be transmitted to client devices belonging to different application sessions. The Shared Service Layer enables new applications to automatically inherit platform capabilities such as artificial intelligence integration, globalization functionality, and authentication services without requiring separate integration efforts for each capability. These capabilities can reduce infrastructure costs by consolidating multiple applications onto shared server resources, improve development velocity by eliminating redundant implementation of common functionality across applications, optimize resource utilization by suspending inactive engine instances while preserving their states, and enable rapid deployment of new interactive applications without requiring development of separate backend systems.

Various implementations of the present disclosure involve the technical field of computer-based session management and communication systems for multiplayer interactive applications, including executing algorithms to generate session identifiers and pair them with application identifiers, directing messages to correct application sessions without interpreting application-specific logic, creating and initializing engine instances within isolated execution environments, suspending engine instances by serializing their current states to persistent storage, restoring engine instances by deserializing saved states from persistent storage, and coordinating multiple concurrent application sessions under unified communication frameworks. These operations are inherently computer-based and cannot be performed in the human mind or using pen and paper due to the volume, speed, and complexity of the data being processed. For example, the system executes the steps of receiving session creation requests from multiple network-connected host console devices, generating globally distinguishable session identifiers for concurrent sessions, establishing real-time bidirectional communication channels with client devices across networks, routing messages between devices based on session identifiers and device identifiers without examining application-specific content, creating isolated execution environments for application-specific logic, serializing complex runtime states into persistent storage formats, and coordinating message transmission across multiple concurrent sessions serving different interactive applications simultaneously. The present disclosure amounts to more than merely implementing a generic computer as a tool to gather, analyze, and output data because the claimed operations improve the field of multiplayer session management by enabling unified coordination of multiple distinct applications that previously required separate backend infrastructures, dynamic resource management through intelligent engine lifecycle control, and prevention of cross-session interference through session identifier isolation. In particular, the speed at which the steps of the present disclosure occur to effectuate the disclosed method, system, or product would involve real-time message routing across concurrent sessions, instantaneous determination of correct application sessions based on session identifiers, immediate establishment of network communication channels when client devices scan machine-readable codes, continuous monitoring of session activity to detect suspension and restoration conditions, and rapid serialization and deserialization of engine states to enable seamless session continuity. That is, the steps of the present method, system, or product are impossible to accomplish on pen and paper, cannot be accomplished as a method of organizing human activity, and amount to more than merely gathering, analyzing, and outputting data.

Various implementations of the present disclosure include executing computer-implemented routing algorithms, session management routines, and lifecycle control processes on computing hardware to coordinate multiple concurrent interactive applications in real-time network environments. The computing system implements these algorithms when it performs tasks such as generating session identifiers that uniquely identify application sessions across all concurrent sessions, pairing session identifiers with application identifiers to enable correct message routing, determining which client devices belong to which application sessions based on session identifier matching, creating isolated execution environments for application-specific logic to prevent cross-interference between concurrent sessions, serializing engine states by converting runtime data structures into persistent storage formats, and deserializing saved states by reconstructing operational engine instances from stored data. In particular, the speed at which the system processes incoming messages from client devices, determines correct application sessions for message delivery, creates and initializes engine instances when required by application identifiers, suspends engine instances by executing serialization routines, and restores engine instances by executing deserialization routines would involve continuous, high-frequency processing across networked systems serving multiple concurrent sessions. As such, the present disclosure would be impossible to accomplish on pen and paper or in the human mind due to the volume of concurrent sessions being coordinated simultaneously, the number of messages being routed in real-time across multiple application sessions, the complexity of serializing and deserializing runtime execution states, and the speed required to maintain responsive interactive experiences across multiple simultaneous applications without perceptible delays.

In some embodiments, the Central Communication Router processes incoming messages by extracting session identifiers from message headers, querying session registries to determine correct application sessions, and transmitting messages to destination client devices without interpreting application-specific content within message payloads. The Session Management Module executes identifier generation algorithms that produce globally distinguishable session identifiers using random number generators or cryptographic hash functions, and stores associations between session identifiers and application identifiers in data repositories for subsequent retrieval. The Engine Instantiation Module queries libraries of application identifiers to determine engine requirements, selects appropriate runtime environments for executing application-specific logic, loads application code from repositories, and initializes execution environments with session-specific parameters. The Lifecycle Management Module monitors session activity metrics to detect inactivity conditions based on connection counts and message transmission timestamps, executes serialization routines that convert runtime states into persistent formats suitable for storage, stores serialized states in persistent storage indexed by session identifiers, and executes deserialization routines that reconstruct operational engine instances from stored states when client devices reconnect. The Onboarding Module executes QR code generation algorithms that encode session identifiers and network endpoints into two-dimensional barcodes following Quick Response code standards. The foregoing operations are executed as sequences of identifier generations, database queries, message routing decisions, serialization conversions, deserialization reconstructions, and network communications across distributed systems, and cannot practically be performed in the human mind or on paper. These concrete processing steps of unified session coordination, dynamic engine lifecycle management, machine-readable code onboarding, and shared service integration provide a specific improvement to multiplayer application hosting systems by enabling multiple distinct applications to operate under common infrastructure rather than requiring separate backend systems for each application, rather than a mere abstract idea of organizing human activity.

The disclosed multi-session platform incorporates several technical features that distinguish it from conventional multiplayer gaming systems. In some embodiments, the platform may implement session-based routing that directs messages to correct application sessions using session identifiers and application identifiers without requiring the Central Communication Router to interpret application-specific logic embedded in message content. Each application session may maintain its own isolated data context through the combination of a session identifier that uniquely identifies the session instance and an application identifier that specifies the type of interactive application being hosted. The Central Communication Router may maintain mapping tables that associate session identifiers with active client device connections and with application identifiers, allowing rapid lookup of destination devices when messages arrive without requiring examination of message payloads. This identifier-based routing ensures that messages from one application session cannot be transmitted to client devices belonging to different application sessions, preventing cross-session interference that could corrupt application states or expose sensitive session data to unauthorized participants. Unlike conventional systems that embed game-specific routing logic directly into communication layers and require modification of routing code when new games are added, the disclosed platform separates routing logic from application logic by using session identifiers as routing keys, enabling the addition of new applications without modifying the core routing infrastructure. The Central Communication Router may validate each outgoing message by comparing the message's session identifier against the session identifier associated with the destination client device, rejecting or quarantining messages that contain mismatched identifiers to enforce session isolation.

In some embodiments, the platform may implement dynamic engine lifecycle management that conserves computational resources by suspending inactive engine instances and restoring them when activity resumes, while maintaining session continuity through state persistence. The Lifecycle Management Module may monitor session activity by tracking the number of connected client devices for each application session and by recording timestamps of recent message transmissions. When the module detects that no client devices remain connected to an application session for a predetermined time period, or when message transmission activity falls below configured thresholds indicating inactivity, the module may initiate suspension processes that save the current state of the engine instance to persistent storage. The suspension process may involve serialization operations that convert runtime data structures, variable values, object instances, and execution contexts into formats suitable for persistent storage such as JavaScript Object Notation (JSON), Extensible Markup Language (XML), binary serialization formats, or custom encoding schemes. The serialization may capture complete snapshots of engine states including application variables, participant data, game progress, scoring information, and any other runtime state necessary to resume execution from the suspended point. When client devices subsequently reconnect to the application session by including the session identifier in reconnection requests, the Lifecycle Management Module may initiate restoration processes that load the saved state from persistent storage and deserialize it back into an operational engine instance. The deserialization process may reconstruct runtime data structures, reinitialize object instances with saved values, restore execution contexts, and reconnect the engine instance to the Central Communication Router for message routing. This dynamic lifecycle management addresses resource utilization challenges in conventional systems that maintain continuously running processes for all possible application sessions regardless of activity levels, wasting computational resources on sessions with no active participants.

In some embodiments, the platform may implement machine-readable code onboarding that streamlines participant joining through automated code scanning rather than manual entry of session identifiers or navigation through application-specific authentication flows. The Onboarding Module may generate Quick Response (QR) codes or other machine-readable codes that encode session identifiers along with network endpoints corresponding to application identifiers. The network endpoints may comprise Uniform Resource Locators (URLs) that specify server addresses where client devices should establish connections, with session identifiers embedded as query parameters or path components within the URLs. When participants scan these codes using camera applications on controller devices such as smartphones or tablets, the devices automatically navigate to the encoded network endpoints and include the session identifiers in connection requests transmitted to the server. This automated onboarding eliminates the need for participants to manually type alphanumeric session codes, memorize session identifiers, or navigate through complex authentication flows, reducing joining friction and enabling rapid onboarding of large numbers of participants in social gaming scenarios. The machine-readable code serves as a visual embodiment of the session identifier, providing a physical representation that can be displayed prominently on heads-up display devices positioned in venues where participants gather. In some embodiments, the network endpoints may direct client devices to registration interfaces that prompt users to enter display names, select avatar images, configure preferences, or provide other information before joining application sessions, with this entered information being transmitted back to the Onboarding Module for processing and device identifier assignment.

In some embodiments, the platform may implement role-based client coordination that assigns different client roles to devices and routes messages according to those role assignments to enable diverse device configurations within application sessions. The Central Communication Router may assign client roles such as host console, heads-up display, or controller to each connected device based on device capabilities, user selections during connection establishment, or configuration parameters associated with the application identifier. Host console devices may be assigned roles that grant permissions to manage administrative controls for application sessions, including creating and configuring sessions, starting and pausing application execution, managing participant lists, and monitoring session status through administrative interfaces. Heads-up display devices may be assigned roles that enable presentation of visual information to multiple participants simultaneously, such as displaying game boards, scoreboards, shared interface elements, question prompts, or other content intended for audience viewing on large screens or projectors. Controller devices may be assigned roles that enable individual participants to submit inputs, view participant-specific information, receive targeted notifications, and interact with application logic through personal interfaces displayed on smartphones or tablets. The Central Communication Router may direct messages to client devices based on their assigned roles by evaluating message types and determining which roles should receive each message type. For example, administrative commands may be routed only to host console devices, shared visual updates may be routed to heads-up display devices, and participant-specific data may be routed to individual controller devices identified by device identifiers. This role-based coordination enables the platform to support diverse device configurations while maintaining consistent message routing logic that does not require knowledge of specific application requirements.

In some embodiments, the platform may implement isolated execution environments that prevent cross-interference between concurrent application sessions by separating runtime resources, memory spaces, and execution contexts. The Engine Instantiation Module may create engine instances within containerized environments or similar isolation mechanisms that provide process-level separation between different engine instances. Each engine instance may execute application-specific logic independently without access to data, variables, or resources belonging to other engine instances executing concurrently on the same server infrastructure. This isolation ensures that errors, crashes, exceptions, or malicious code in one application session cannot affect other concurrent sessions operating on shared hardware. The isolated execution environments may support different runtime environments such as Node.js JavaScript engines, .NET Common Language Runtime environments, Java Virtual Machines, Python interpreters, or other execution platforms selected according to parameters corresponding to application identifiers, enabling the platform to host applications developed in diverse programming languages and frameworks without requiring standardization on a single technology stack. In some embodiments, the Engine Instantiation Module may allocate dedicated memory pools, processor time slices, and network bandwidth quotas to each engine instance to ensure fair resource distribution and to prevent resource exhaustion in one session from degrading performance in other sessions.

In some embodiments, the platform may incorporate a Shared Service Layer that provides standardized capabilities accessible to all application sessions through common interfaces, eliminating the need for individual applications to implement separate integrations for common functionality. The Shared Service Layer may expose functions for artificial intelligence integration, enabling applications to invoke AI-powered features such as natural language processing for chat moderation, content generation for dynamic question creation, participant assistance through automated help systems, or game logic augmentation through intelligent difficulty adjustment. The layer may expose globalization and localization functions that translate application content, interface text, and dynamic messages into multiple supported languages based on participant language preferences stored during onboarding, eliminating the need for applications to implement separate translation systems or maintain multilingual content databases. The layer may expose authentication functions that verify participant identities, manage user credentials, enforce access controls, and integrate with external authentication providers through standardized security protocols such as OAuth or Security Assertion Markup Language (SAML). Each application session may access these shared capabilities by invoking interface methods provided by the Shared Service Layer through application programming interfaces (APIs) or function calls, with the layer executing the requested functions and returning results to the calling application. This shared service approach enables new applications to automatically inherit platform capabilities without requiring separate integration efforts for each capability, accelerating development timelines and ensuring consistent behavior across all hosted applications.

In some embodiments, the platform may implement real-time bidirectional communication channels that enable low-latency message transmission between the server and client devices to support responsive interactive experiences. The Communication Module may establish network communication channels using protocols such as WebSocket, Server-Sent Events (SSE), or custom real-time protocols that maintain persistent connections between the server and client devices throughout application session durations. These bidirectional channels enable the server to push messages to client devices immediately when application events occur, without requiring client devices to continuously poll the server for updates. The Central Communication Router may maintain message queues for each application session to buffer incoming and outgoing messages, ensuring that message delivery order is preserved when multiple messages are transmitted simultaneously and that temporary network disruptions do not result in message loss. In some embodiments, the Communication Module may implement connection management logic that detects disconnected devices, attempts automatic reconnection when network connectivity is restored, and notifies the Lifecycle Management Module when all devices in a session have disconnected to trigger suspension processes.

These technical features may collectively transform multiplayer application hosting from an application-specific development model requiring separate backend infrastructure for each game into a unified platform model that enables multiple distinct applications to share common coordination, onboarding, and resource management infrastructure. Whereas conventional systems require developers to implement session management, participant onboarding, server-side processing, and infrastructure management separately for each application, the disclosed platform provides these capabilities as shared services that new applications automatically inherit. By integrating session-based routing, dynamic lifecycle management, machine-readable code onboarding, role-based client coordination, isolated execution environments, and shared service layers into a unified multi-session platform, the system may address fundamental limitations in current multiplayer gaming architectures that result in duplicated development efforts, inefficient resource utilization, and operational complexity when hosting multiple applications.

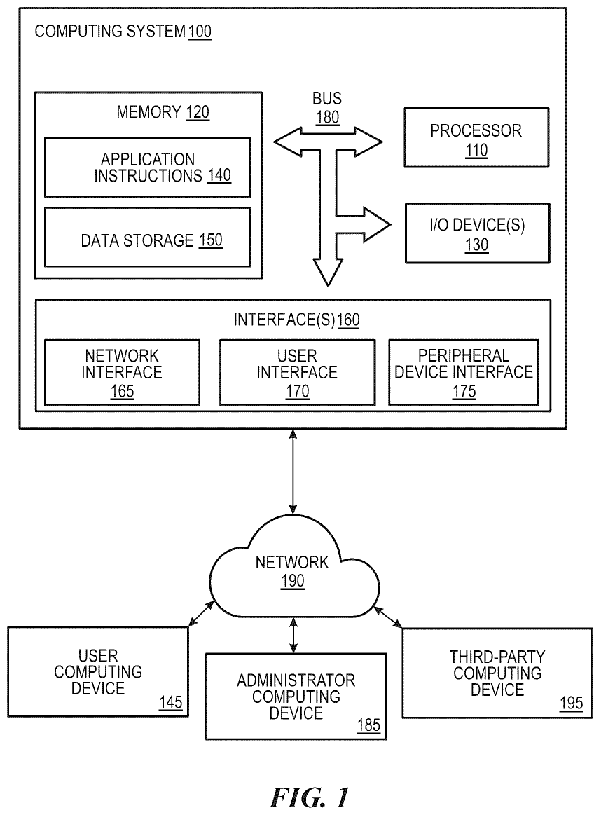

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, a medical diagnostic machine, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, depth sensors, biometric scanners, or environmental sensors. In industrial or medical environments, the I/O devices 130 may include robotic actuators, infusion pumps, or diagnostic imaging scanners. In vehicular environments, the I/O devices 130 may include in-cabin displays, steering sensors, and connected infotainment systems.

The computing system 100 further comprises one or more interfaces 160 that enable communication with other systems, users, or peripheral components. The network interface 165 allows the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart appliance configured to execute client-side applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 may be deployed in a client-server model, where the computing system 100 acts as a backend server managing requests from client devices. In other embodiments, the computing system 100 may function within a cloud-native environment, operating as a microservice within a container orchestration platform. In edge deployments, the computing system 100 may be optimized for low-latency local processing, while synchronizing with centralized cloud infrastructure for data persistence and global coordination.

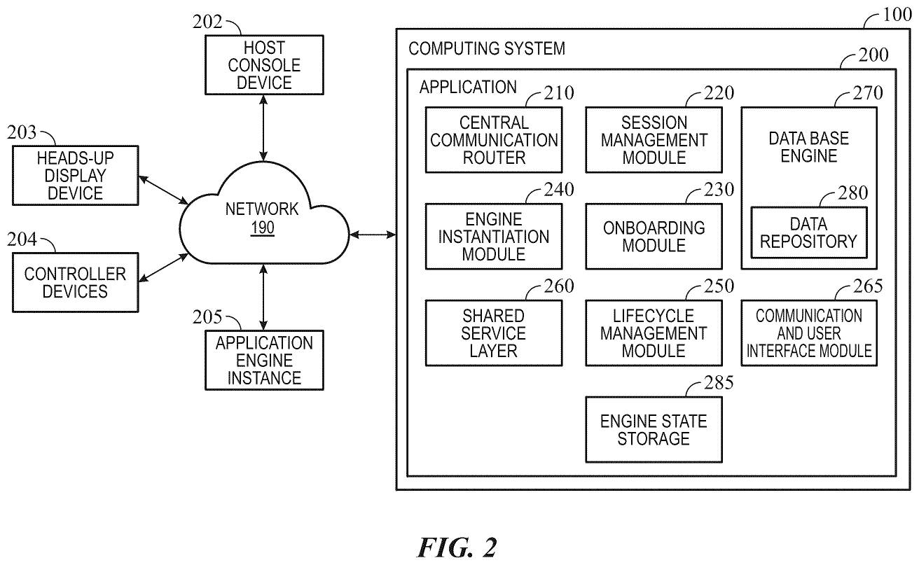

FIG. 2 illustrates an example computer architecture for the application program 200 operated via the computing system 100. The computing system 100 comprises several modules and engines configured to execute the functionalities of the application program 200, and a database engine 270 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises a Central Communication Router 210, a Session Management Module 220, an Onboarding Module 230, an Engine Instantiation Module 240, a Lifecycle Management Module 250, a Shared Service Layer 260, and a Communication and User Interface Module 265. The application program 200 further interfaces with a Database Engine 270 that manages operations for the Data Repository 280 and Engine State Storage 285. The computing system 100 communicates via Network 190 with external devices including Host Console Device 202, Heads-Up Display Device 203, Controller Devices 204, and Application Engine Instance 205.

In some embodiments, the Central Communication Router 210 may be configured to control message flow for application sessions by directing messages to correct destinations without interpreting application-specific content. The Central Communication Router 210 may be configured to maintain a plurality of application sessions concurrently, wherein each application session of the plurality of application sessions is identified by a session identifier and an application identifier. The maintenance of concurrent sessions may involve storing session metadata in memory-resident data structures that associate each session identifier with its corresponding application identifier, connected client device identifiers, assigned client roles, and session status indicators. In some embodiments, the Central Communication Router 210 may be further configured to receive messages from client devices and direct the messages to a correct application session via the session identifier and the application identifier, wherein the Central Communication Router 210 determines the correct application session without interpreting content of the messages. The message reception process may occur through the Communication and User Interface Module 265, which establishes network connections and receives data packets from client devices via the Network 190. When a message arrives, the Central Communication Router 210 may extract the session identifier from message headers, metadata fields, or structured message parameters that accompany the message payload. The Central Communication Router 210 may then query session registries maintained by the Session Management Module 220 using the extracted session identifier to retrieve the associated application identifier and to verify that the session identifier corresponds to an active application session. Once the correct application session is identified through this lookup process, the Central Communication Router 210 may determine message destinations by evaluating the client role assigned to the sending device and by identifying which client devices within the application session should receive the message based on message type indicators. In some embodiments, the Central Communication Router 210 may direct messages to each client device of a plurality of client devices according to the assigned client role, wherein the assigned client role comprises at least one of a host console configured to manage administrative controls for the application session, a heads-up display configured to present visual information to multiple participants, or a controller configured to receive input from an individual participant. The direction of messages according to client roles may be accomplished by maintaining role-based routing tables that map message types to authorized recipient roles, and by filtering destination device lists to include only devices whose assigned roles match the authorized recipient roles for each message type. For example, administrative command messages may be directed only to devices assigned the host console role, shared visual update messages may be directed to devices assigned the heads-up display role, and participant-specific data messages may be directed to individual devices assigned the controller role using device identifiers to select specific recipient devices. The Central Communication Router 210 may maintain message queues for each application session to buffer incoming and outgoing messages, ensuring that message delivery order is preserved and that concurrent message processing does not result in delivery sequence errors. In some embodiments, the Central Communication Router 210 may be configured to prevent messages from one application session of the plurality of application sessions from being transmitted to client devices belonging to a different application session of the plurality of application sessions through use of the session identifier. This prevention may be accomplished by validating that each message's embedded session identifier matches the session identifier associated with each destination client device before transmission occurs, and by rejecting or quarantining messages that contain mismatched session identifiers. The validation process may involve comparing the session identifier extracted from the message against a session identifier field stored in connection records for each destination device, with transmission proceeding only when these identifiers match exactly. When application sessions require server-side processing, the Central Communication Router 210 may retrieve engine instance references from the Engine Instantiation Module 240 and may transmit messages to those engine instances for processing before routing response messages back to client devices within the application session. In some embodiments, the Central Communication Router 210 may be further configured to coordinate multiple distinct application sessions comprising different application identifiers simultaneously under a unified communication framework, wherein each application session of the plurality of application sessions operates independently from other application sessions via the session identifier. This coordination may involve maintaining separate message routing contexts, client device connection lists, and message queues for each unique session identifier while sharing common routing infrastructure, network connections, and processing resources across all concurrent sessions. The independent operation of sessions may be ensured by isolating all message routing decisions to session-specific data structures indexed by session identifiers, preventing any message routing operation from accessing or affecting data belonging to sessions with different session identifiers. The Central Communication Router 210 may communicate operational events to the Lifecycle Management Module 250, including notifications when new client devices connect to sessions by transmitting connection requests containing session identifiers, when existing devices disconnect by closing network connections, or when sessions experience extended periods without message activity as determined by monitoring timestamps of most recent message transmissions for each session identifier.

In some embodiments, the Session Management Module 220 may be configured to generate identifiers that distinguish application sessions and to maintain associations between those identifiers and application types. The Session Management Module 220 may be configured to generate the session identifier for each application session of the plurality of application sessions, wherein the session identifier corresponds to the application identifier. The generation process may involve executing identifier creation algorithms that produce alphanumeric codes, numeric sequences, universally unique identifier (UUID) values, or globally unique identifier (GUID) values that have extremely low probability of collision with identifiers for other concurrent sessions. In some embodiments, the Session Management Module 220 may generate session identifiers by invoking random number generators that produce cryptographically secure random values, by applying hash functions such as SHA-256 to combinations of current timestamps and server identity information, or by incrementing sequential counters that ensure each generated identifier differs from all previously issued identifiers. The Session Management Module 220 may receive session creation requests from host console devices via the Communication and User Interface Module 265, wherein such requests specify which interactive application the host user wishes to instantiate by providing an application name, application category, or application identifier selection. Upon receiving a session creation request, the Session Management Module 220 may extract the application identifier corresponding to the requested application type from the request parameters or by looking up the application identifier in application catalogs based on application names provided in requests. The Session Management Module 220 may then pair the generated session identifier with this application identifier by creating association records in the Data Repository 280 via the Database Engine 270. The pairing operation may involve inserting database records, creating hash table entries, or populating data structures that link each session identifier to its corresponding application identifier, enabling subsequent queries that provide only a session identifier to retrieve the associated application identifier. In some embodiments, the Session Management Module 220 may maintain session identifier registries that store active session identifiers along with their corresponding application identifiers, session creation timestamps, host user identifiers, session configuration parameters, and session status indicators such as active, suspended, or terminated. These registries may be implemented as in-memory data structures such as hash maps, associative arrays, or indexed collections that enable rapid lookup operations by the Central Communication Router 210 when incoming messages must be routed to correct application sessions. The Session Management Module 220 may synchronize in-memory registries with persistent storage in the Data Repository 280 at regular intervals or following each registry modification to ensure that session data survives server restarts or failures. The Session Management Module 220 may return generated session identifiers to the Onboarding Module 230 for encoding into machine-readable codes, enabling participants to join sessions by scanning those codes with client devices. In some embodiments, the Session Management Module 220 may update session status indicators when sessions transition between states, such as marking sessions as active when client devices connect by including session identifiers in connection requests, marking sessions as suspended when the Lifecycle Management Module 250 notifies the module that engine instances have been suspended due to inactivity, or marking sessions as terminated when host users explicitly close sessions through administrative commands. The Session Management Module 220 may enforce session lifecycle policies by monitoring session age based on creation timestamps and by automatically terminating sessions that exceed predetermined expiration periods such as 24 hours, 7 days, or other configured durations. The module may also monitor session inactivity by comparing current timestamps to timestamps of most recent session activity, automatically terminating sessions that have been inactive for extended periods beyond configured inactivity thresholds.

In some embodiments, the Onboarding Module 230 may be configured to facilitate participant joining by producing codes that participants can scan to automatically connect to application sessions. The Onboarding Module 230 may be configured to produce a machine-readable code encoding the session identifier and a network endpoint corresponding to the application identifier, wherein scanning the machine-readable code directs a client device to a registration interface where a user enters information to join the application session. The machine-readable code production process may involve receiving session identifiers from the Session Management Module 220 following session creation operations, and retrieving network endpoint information associated with the application identifier for the session from configuration data stored in the Data Repository 280 or from application catalogs maintained by the application program 200. Network endpoints may comprise Uniform Resource Locators (URLs) that specify protocol schemes such as “https://”, domain names or IP addresses identifying server locations, port numbers when non-standard ports are used, and path components or query parameters that include session identifiers. In some embodiments, the Onboarding Module 230 may construct network endpoints by combining base server addresses retrieved from server configuration data with session-specific parameters, producing URLs such as “https://game.example.com/join? session=ABC123XYZ” where “ABC123XYZ” represents the session identifier embedded as a query parameter value. The Onboarding Module 230 may encode both the session identifier and the network endpoint into machine-readable code formats by invoking code generation libraries or algorithms. In some embodiments, the machine-readable code may be a Quick Response (QR) code, and the QR code serves as a visual embodiment of the session identifier. The QR code generation process may involve invoking QR code encoding libraries that convert text strings containing network endpoints into two-dimensional matrix barcodes following International Organization for Standardization (ISO) standards for QR codes, with error correction levels selected to ensure codes remain scannable even when partially obscured or damaged. The Onboarding Module 230 may select error correction levels such as Low (L), Medium (M), Quartile (Q), or High (H) based on expected display conditions and scanning environments, with higher error correction levels providing greater resilience to damage at the cost of increased code density. The generated machine-readable code may be formatted as image data in formats such as Portable Network Graphics (PNG), Scalable Vector Graphics (SVG), or Joint Photographic Experts Group (JPEG) for display on visual output devices. In some embodiments, the Onboarding Module 230 may transmit generated machine-readable codes to heads-up display devices via the Central Communication Router 210 and Communication and User Interface Module 265, where the codes are presented prominently on large screens, projectors, or display monitors positioned for easy scanning by participants. When participants scan the machine-readable codes using camera applications, barcode scanning applications, or QR code reader functions on controller devices such as smartphones or tablets, the scanning applications automatically extract the encoded network endpoint and navigate the controller device's web browser or application interface to the extracted URL. The navigation process may cause the controller device to transmit connection requests to the server identified in the network endpoint, with the session identifier included as a parameter in the connection request. In some embodiments, the network endpoint may direct client devices to registration interfaces hosted by the application program 200, wherein the registration interfaces prompt users to enter display names by providing text input fields, to select avatar images or participant icons by choosing from galleries of available images, to configure language preferences by selecting from lists of supported languages, or to provide other information required before joining application sessions. The Onboarding Module 230 may receive this entered information from client devices via the Communication and User Interface Module 265 when users submit registration forms, and may process the information by validating that required fields are completed, by checking that display names meet length and character requirements, and by storing participant profile data in the Data Repository 280 indexed by session identifiers. In some embodiments, the Onboarding Module 230 may assign device identifiers to each client device of the plurality of client devices that connects to application sessions. The device identifier assignment process may involve generating unique identifiers using similar techniques as session identifier generation, such as producing random alphanumeric codes or UUID values that distinguish each device from other devices within the same application session and across different application sessions. The Onboarding Module 230 may store associations between device identifiers, session identifiers, and user profile information in the Data Repository 280, enabling the Central Communication Router 210 to route targeted messages to individual devices by specifying device identifiers as message destinations. In some embodiments, the Onboarding Module 230 may assign client roles to each client device of the plurality of client devices for the application session, wherein the assigned client role determines which types of messages devices receive and which interface functions devices can access. The client role assignment process may involve determining device types by analyzing user agent strings transmitted by client devices during connection establishment, by examining screen size and capability information reported by devices, or by allowing users to explicitly select roles during registration through role selection interfaces. Devices accessing the system through large displays or administrative portals may be assigned the host console role, devices identified as having large screens or configured for audience viewing may be assigned the heads-up display role, and devices identified as smartphones or tablets used by individual participants may be assigned the controller role. The Onboarding Module 230 may communicate assigned client roles to the Central Communication Router 210 for use in role-based message routing decisions, and may transmit role assignments to the Communication and User Interface Module 265 to enable generation of role-specific interfaces appropriate for each device's assigned role.

In some embodiments, the Engine Instantiation Module 240 may be configured to create and manage execution environments for application-specific logic that requires server-side processing. The Engine Instantiation Module 240 may be configured to create and initialize an engine instance for at least one application session of the plurality of application sessions, wherein the engine instance executes application-specific logic within an isolated execution environment separate from other engine instances. The engine instance creation process may be initiated when the Central Communication Router 210 determines that an application identifier requires server-side processing by querying application requirement metadata that indicates whether each application type executes entirely on client devices or requires server-side computation. Upon determining that server-side processing is required, the Central Communication Router 210 may transmit engine instantiation requests to the Engine Instantiation Module 240, including the session identifier and application identifier for which an engine instance should be created. In some embodiments, the Engine Instantiation Module 240 may query application libraries stored in the Data Repository 280 to determine engine requirements corresponding to the application identifier, including which runtime environment should be used, which application code files should be loaded, which initialization parameters should be provided, and which resource limits should be enforced. The Engine Instantiation Module 240 may determine a selectable runtime environment for the engine instance based on the application identifier, wherein the selectable runtime environment is selected from a plurality of available runtime environments such as Node.js JavaScript engines for executing JavaScript applications, .NET Common Language Runtime environments for executing C #or Visual Basic applications, Java Virtual Machines for executing Java applications, Python interpreters for executing Python applications, or other execution platforms supported by the server infrastructure. The runtime environment selection may be accomplished by retrieving runtime specification metadata associated with each application identifier that indicates the required execution platform, and by launching or connecting to an instance of the specified runtime environment. In some embodiments, the Engine Instantiation Module 240 may create isolated execution environments by instantiating containerized environments using container technologies such as Docker containers, Linux Containers (LXC), or similar isolation mechanisms that provide process-level separation, filesystem isolation, and network namespace separation. Each engine instance may execute within its own container that has dedicated memory allocations, isolated filesystem spaces that prevent access to files belonging to other containers, separate network interfaces for communication isolation, and resource limits that cap processor usage, memory consumption, and network bandwidth to prevent resource exhaustion. The isolation ensures that errors, exceptions, crashes, or malicious code executing in one engine instance cannot access memory, variables, files, or resources belonging to other engine instances executing concurrently on the same server, and cannot cause failures that affect other application sessions. In some embodiments, the Engine Instantiation Module 240 may load application-specific logic from the Data Repository 280 by retrieving application code files, configuration files, asset files, and dependency libraries associated with the application identifier. The loading process may involve copying files into the isolated execution environment's filesystem, installing required software dependencies or packages, and configuring execution parameters such as memory limits, timeout values, or logging settings. The Engine Instantiation Module 240 may initialize the engine instance by executing application startup routines, loading the session identifier and application identifier into the engine instance's runtime context so application code can access these identifiers, restoring any session-specific state data if the session is being restored from suspension, and establishing communication connections between the engine instance and the Central Communication Router 210. In some embodiments, the Engine Instantiation Module 240 may establish connections between engine instances and the Central Communication Router 210 by configuring inter-process communication channels, network socket connections, message queues, or application programming interface (API) endpoints through which messages can be transmitted bidirectionally. The connection establishment may involve the engine instance registering its session identifier with the Central Communication Router 210, enabling the router to include the engine instance in message routing decisions for that session identifier. The Engine Instantiation Module 240 may communicate with the Lifecycle Management Module 250 to register newly created engine instances as active and to provide engine instance references that the Lifecycle Management Module 250 can use for subsequent monitoring and management operations. In some embodiments, when the application identifier indicates that server-side processing is not required because the application executes entirely on client devices, the Engine Instantiation Module 240 may not create an engine instance, and the Central Communication Router 210 may transmit messages directly between client devices without involving server-side application logic processing.

In some embodiments, the Lifecycle Management Module 250 may be configured to monitor and manage the operational states of engine instances to optimize resource utilization while preserving session continuity. The Lifecycle Management Module 250 may be configured to manage the engine instance by suspending the engine instance when session activity indicates inactivity, wherein the Lifecycle Management Module 250 saves a current state of the engine instance to persistent storage when suspending, and restores the engine instance by loading the saved state from the persistent storage when a client device subsequently reconnects to the application session. The engine instance management process may begin with session activity monitoring, wherein the Lifecycle Management Module 250 tracks metrics such as the number of client devices connected to each application session by querying connection counts maintained by the Central Communication Router 210, and tracks timestamps of recent message transmissions for each session identifier by receiving timestamp updates from the Central Communication Router 210 whenever messages are routed for each session. In some embodiments, the Lifecycle Management Module 250 may detect session inactivity when no client devices remain connected to the application session, as indicated by connection count values reaching zero, or when message transmission activity falls below predetermined activity thresholds such as no messages being transmitted for a specified time period like 5 minutes, 15 minutes, or other configured durations. Upon detecting inactivity conditions, the Lifecycle Management Module 250 may initiate suspension processes by first notifying the engine instance that suspension is about to occur, allowing the application-specific logic to execute cleanup routines or reach stable suspension points. The Lifecycle Management Module 250 may then save the current state of the engine instance to persistent storage in the Engine State Storage 285 via the Database Engine 270. In some embodiments, suspending the engine instance may comprise converting the current state of the engine instance into a serialized format for storage. The serialization process may involve invoking serialization libraries or functions provided by the runtime environment that convert runtime data structures, object instances, variable values, execution contexts, and application state information into formats suitable for persistent storage. The serialized formats may include JavaScript Object Notation (JSON) for JavaScript-based applications, Extensible Markup Language (XML) for applications requiring structured hierarchical data representation, binary serialization formats such as Protocol Buffers or MessagePack for efficient storage of complex data structures, or custom serialization schemes implemented by application-specific logic. The serialization may capture complete snapshots of engine states including all application variables such as game scores, player positions, inventory contents, or progress indicators; participant data such as player lists, team assignments, or turn orders; temporal data such as elapsed time, remaining time, or scheduled events; and any other runtime state necessary to resume execution from the suspended point without requiring participants to restart or lose progress. In some embodiments, the Lifecycle Management Module 250 may store the serialized state data in the Engine State Storage 285 indexed by the session identifier, enabling subsequent retrieval of the correct state data when the session is restored. The storage operation may involve writing serialized data to database records, file storage systems, object storage services, or in-memory data stores such as Redis or Memcached with persistence enabled. After successfully saving the current state, the Lifecycle Management Module 250 may terminate the engine instance by stopping the execution environment, releasing allocated memory resources, closing network connections, and removing the containerized environment or process. The termination frees computational resources that were allocated to the inactive session, enabling those resources to be reallocated to active sessions or other system processes. In some embodiments, restoring the engine instance may comprise converting the saved state from the serialized format back into an operational state. The restoration process may be initiated when the Lifecycle Management Module 250 receives notifications from the Central Communication Router 210 that client devices have reconnected to the application session by transmitting connection requests containing the session identifier associated with the suspended session. Upon receiving such notifications, the Lifecycle Management Module 250 may request the Engine Instantiation Module 240 to create a new engine instance for the session identifier using the same application identifier as the original instance. The Lifecycle Management Module 250 may then load the saved state from the Engine State Storage 285 by retrieving the serialized state data indexed by the session identifier, and may deserialize the saved state by invoking deserialization libraries or functions that convert the serialized data back into runtime data structures, object instances, variable values, and execution contexts. The deserialization process may reconstruct the engine's runtime state to match the state that existed at the moment of suspension, restoring all application variables, participant data, temporal information, and other state components. The Lifecycle Management Module 250 may provide the deserialized state to the newly created engine instance through initialization parameters, state loading functions exposed by the application-specific logic, or by directly injecting state data into the engine instance's runtime context. Once the state is restored, the engine instance resumes execution from the suspended point, enabling application logic to continue processing as though the suspension had not occurred. Participants reconnecting to the session may observe that their progress, scores, positions, and other session data remain exactly as they were before disconnection, providing seamless continuity despite the engine instance having been suspended and computational resources having been released during the inactivity period. In some embodiments, the Lifecycle Management Module 250 may be further configured to terminate the engine instance when the Lifecycle Management Module 250 detects that no client devices remain connected to the application session for a predetermined time period that exceeds configured session expiration thresholds. The termination operation may involve deleting the saved state from the Engine State Storage 285 and notifying the Session Management Module 220 to mark the session identifier as terminated in session registries, preventing future reconnection attempts and releasing session identifier values for potential reuse.

In some embodiments, the Shared Service Layer 260 may be configured to provide common capabilities accessible to all application sessions without requiring individual applications to implement separate integrations for each capability. The Shared Service Layer 260 may be configured to provide standardized capabilities comprising at least one of artificial intelligence integration, globalization functionality, localization functionality, or authentication services, wherein the standardized capabilities are accessible to all application sessions via a common interface. The common interface may be implemented as an application programming interface (API) that exposes functions, methods, or endpoints that application-specific logic executing within engine instances can invoke to access shared services. In some embodiments, the artificial intelligence integration capability may enable applications to invoke AI-powered features by submitting requests to the Shared Service Layer 260 that are processed using machine learning models, natural language processing systems, speech synthesis systems, or AI inference engines. The AI integration may provide content generation services that create dynamic questions, generate story narratives, produce personalized recommendations, create procedurally generated game content based on parameters provided by applications, or generate dynamic dialogue scripts and corresponding AI-generated voice outputs using text-to-speech or neural voice models. The AI integration may provide participant assistance services that analyze participant questions submitted through chat interfaces, generate helpful responses using conversational AI models, or provide hints and guidance customized to each participant's progress and skill level. The AI integration may provide game logic augmentation services that adjust difficulty levels dynamically based on participant performance patterns, balance team compositions to ensure fair gameplay, or detect anomalous behavior patterns that may indicate cheating or abuse. In some embodiments, the globalization functionality may enable applications to support international audiences by providing services that adapt content, formatting, and presentation to different regional requirements. The globalization services may include currency conversion functions that display monetary values in participants'local currencies, date and time formatting functions that present temporal information according to regional conventions, and numeric formatting functions that use appropriate decimal separators and digit grouping based on locale settings. In some embodiments, the localization functionality may provide translation services that convert application content, interface text, dynamic messages, and user-generated content into multiple supported languages. The localization services may maintain translation databases containing message strings in supported languages, indexed by message identifiers and language codes following standards such as ISO 639 language codes. When application-specific logic needs to display text to participants, it may invoke localization functions provided by the Shared Service Layer 260 by supplying message identifiers and participant language preferences retrieved during onboarding, receiving translated message strings appropriate for each participant's selected language. The translation services may support real-time translation of user-generated content such as chat messages or participant-created questions by integrating with machine translation APIs or by applying neural machine translation models. In some embodiments, the authentication services may verify participant identities, manage user credentials, enforce access controls, and integrate with external authentication providers. The authentication services may support multiple authentication mechanisms including username and password authentication with secure password hashing using algorithms such as bcrypt or Argon2, social authentication that enables participants to sign in using accounts from providers such as Google, Facebook, or Apple through OAuth 2.0 protocols, single sign-on (SSO) integration that enables participants to use existing organizational credentials through protocols such as Security Assertion Markup Language (SAML) or OpenID Connect, and multi-factor authentication that requires additional verification factors beyond passwords such as time-based one-time passwords (TOTP) or SMS codes. The Shared Service Layer 260 may expose these authentication services through API functions that application-specific logic can invoke to verify participant credentials, retrieve participant profile information, check authorization permissions, or manage session tokens. In some embodiments, each application session may access the standardized capabilities by invoking interface methods exposed by the Shared Service Layer 260, wherein the invocations include request parameters specifying which service is needed and what input data should be processed. The Shared Service Layer 260 may execute the requested functions by processing input data, invoking underlying service implementations, and returning service response data to the calling application. The service responses may include generated content from AI services, translated text from localization services, formatted values from globalization services, or authentication verification results from authentication services. By providing these capabilities as shared services, the Shared Service Layer 260 enables new applications to automatically inherit platform capabilities without requiring developers to implement separate AI integrations, translation systems, authentication mechanisms, or globalization logic for each application, significantly reducing development time and ensuring consistent behavior across all hosted applications.

In some embodiments, the Communication and User Interface Module 265 may be configured to establish and maintain network connections with client devices and to generate interfaces appropriate for each device's assigned role. The Communication and User Interface Module 265 may establish network communication channels between the server and client devices using real-time communication protocols. In some embodiments, the network communication channel may comprise a real-time bidirectional communication protocol, and the Central Communication Router 210 maintains one or more message queues for each application session of the plurality of application sessions to facilitate real-time communication among all client devices assigned to that application session. The real-time bidirectional communication protocols may include WebSocket connections that maintain persistent bidirectional channels enabling both client-initiated and server-initiated message transmission, Server-Sent Events (SSE) that enable server-push capabilities for streaming updates to client devices, HTTP long-polling mechanisms where clients maintain open requests that servers respond to when new data becomes available, or custom protocols implemented over TCP or UDP network transports. The Communication and User Interface Module 265 may listen for incoming connection requests from client devices on designated network ports, authenticate connection requests by verifying session identifiers and credentials, perform connection handshake procedures following protocol specifications, and register established connections with the Central Communication Router 210 by associating connection handles with session identifiers and device identifiers. In some embodiments, the Communication and User Interface Module 265 may implement connection management logic that monitors connection health by sending periodic heartbeat or ping messages and expecting responses within timeout periods, detects disconnected devices when connections close unexpectedly or heartbeat responses are not received, attempts automatic reconnection by allowing disconnected devices to re-establish connections using stored session identifiers and device identifiers without requiring re-onboarding, and notifies the Central Communication Router 210 and Lifecycle Management Module 250 when devices connect or disconnect so appropriate session management actions can be taken. The Communication and User Interface Module 265 may generate user interfaces customized for each client device based on the assigned client role retrieved from the Onboarding Module 230 or Central Communication Router 210. In some embodiments, the user interfaces may be implemented as web-based interfaces transmitted to client devices as Hypertext Markup Language (HTML) documents with associated Cascading Style Sheets (CSS) for styling and JavaScript code for interactivity, as native mobile application screens rendered by application software installed on controller devices, or as application programming interfaces (APIs) that enable programmatic access for specialized client implementations. Host console devices may receive administrative interfaces displaying session status information such as connected participant counts, session duration timers, and application state summaries; control panels enabling session management actions such as starting, pausing, stopping, or resetting applications; participant management tools for viewing participant lists, removing disruptive participants, or reassigning teams; and monitoring displays showing message traffic, system performance metrics, or error logs. Heads-up display devices may receive presentation interfaces optimized for large-screen viewing and audience visibility, displaying shared game boards with prominent visual elements, scoreboards showing participant rankings and scores with large fonts and contrasting colors, question prompts or game instructions presented centrally for all participants to view simultaneously, and animations or visual effects that enhance the viewing experience for audiences. Controller devices may receive participant interfaces optimized for individual interaction on mobile devices, displaying input controls such as buttons, sliders, or text fields for submitting responses and actions; participant-specific information such as personal scores, inventory contents, or status indicators; real-time feedback on submitted actions such as correctness indicators for answers or confirmation messages for completed actions; and chat or communication features enabling participants to send messages within application sessions. The Communication and User Interface Module 265 may update displayed interfaces dynamically by transmitting interface update messages to client devices when application state changes occur, such as when scores change, when new questions or prompts are presented, when participants join or leave sessions, or when application logic generates events requiring interface updates.

In some embodiments, the Database Engine 270 may be configured to manage data storage and retrieval operations for persistent data used by the application program 200. The Database Engine 270 may execute database queries submitted by other components of the application program 200 through structured query language (SQL) statements, NoSQL query operations, or object-relational mapping (ORM) operations. The Database Engine 270 may manage structured data storage in the Data Repository 280 by organizing data into tables, collections, or other data structures appropriate for the database management system being used. In some embodiments, the Database Engine 270 may execute create operations that insert new records into the Data Repository 280 when sessions are created, client devices are onboarded, or application events generate new data; read operations that retrieve existing records when components need to access stored data such as session registries, application configurations, or participant profiles; update operations that modify existing records when session states change, participant information is edited, or configuration values are adjusted; and delete operations that remove records when sessions are terminated, devices are removed, or data retention policies require old data to be purged. The Database Engine 270 may maintain indexes on frequently queried data fields such as session identifiers, device identifiers, and application identifiers to enable rapid lookup operations without requiring full table scans. In some embodiments, the Database Engine 270 may enforce data integrity constraints such as primary key uniqueness constraints ensuring each session identifier appears only once in session registries, foreign key constraints ensuring device identifiers reference valid session identifiers, and validation constraints ensuring stored data meets format and range requirements. The Database Engine 270 may manage concurrent access to data by implementing transaction management mechanisms that prevent data corruption when multiple components attempt to read and write data simultaneously, applying locking mechanisms that serialize conflicting operations, and ensuring atomicity, consistency, isolation, and durability (ACID) properties for critical data operations. In some embodiments, the Database Engine 270 may synchronize data with external systems by exporting session data, application logs, or participant information to external databases, data warehouses, or analytics platforms through scheduled synchronization jobs, real-time replication mechanisms, or API-based data exchange protocols.

In some embodiments, the Data Repository 280 may store structured data used by the application program 200 across multiple operational contexts. The Data Repository 280 may contain session registry records including session identifiers, application identifiers, host user identifiers, session creation timestamps, session status indicators, and session configuration parameters. The Data Repository 280 may contain application catalog records including application identifiers, application names, application descriptions, runtime environment specifications, application code file references, and application requirement metadata. The Data Repository 280 may contain device registration records including device identifiers, session identifiers associating devices with sessions, assigned client roles, user profile information such as display names and language preferences, and device connection timestamps. The Data Repository 280 may contain user account records including user identifiers, authentication credentials such as hashed passwords, user profile information, authentication token data, and account status indicators. The Data Repository 280 may contain configuration data including server endpoint addresses, network port configurations, supported language lists, service provider credentials for external integrations, and operational parameters such as session timeout thresholds and resource limits. In some embodiments, the Data Repository 280 may be implemented as a relational database management system such as PostgreSQL, MySQL, or Microsoft SQL Server; as a NoSQL database system such as MongoDB, Cassandra, or DynamoDB; or as a distributed data storage system spanning multiple servers for scalability and redundancy. The Data Repository 280 may be accessed exclusively through the Database Engine 270, which provides abstraction and ensures consistent data access patterns across all components of the application program 200.

In some embodiments, the Engine State Storage 285 may store serialized engine instance states for suspended sessions. The Engine State Storage 285 may contain serialized state records indexed by session identifiers, wherein each record contains the complete serialized representation of an engine instance's runtime state at the moment of suspension. The serialized state records may include all application variables, participant data, temporal information, event queues, and any other state data required to restore engine instances to operational condition. In some embodiments, the Engine State Storage 285 may be implemented using high-performance storage systems optimized for rapid read and write operations such as solid-state drive (SSD) storage arrays, in-memory data stores with persistence such as Redis with RDB or AOF persistence enabled, or object storage services such as Amazon S3 or Azure Blob Storage. The Engine State Storage 285 may be accessed by the Lifecycle Management Module 250 during suspension operations to store serialized states and during restoration operations to retrieve serialized states for deserialization.

In some embodiments, the Network 190 may be a public or private data network enabling communication between the computing system 100 and external client devices. The Network 190 may utilize standard communication protocols such as Transmission Control Protocol/Internet Protocol (TCP/IP), Hypertext Transfer Protocol Secure (HTTPS), WebSocket protocols, or other network protocols to facilitate data transmission between connected systems. In some embodiments, the Network 190 may correspond to the global Internet, enabling client devices to connect from any location with Internet connectivity; to local area networks (LANs) within venues, offices, or homes where client devices and servers operate on the same private network; to wide area networks (WANs) connecting distributed locations; or to mobile cellular networks enabling controller devices such as smartphones to connect via 4G LTE, 5G, or other cellular data services. The Network 190 may implement security measures such as encryption using Transport Layer Security (TLS) protocols, firewall rules restricting unauthorized access to server ports, and intrusion detection systems monitoring for malicious traffic patterns.

Host Console Device 202 may be computing devices used by host users to create and manage application sessions. In some embodiments, Host Console Device 202 may be desktop computers with large monitors and keyboards enabling efficient administrative operations, laptop computers providing portability for hosts who manage sessions from different locations, or tablet devices with touch interfaces for simplified session management. The Host Console Device 202 may execute web browsers or dedicated host applications that interface with the Communication and User Interface Module 265 to display administrative interfaces. Host users may interact with Host Console Device 202 to request creation of application sessions by selecting application types and configuring session parameters, to start, pause, stop, or reset application execution through control interfaces, to monitor session activity including connected participant counts and application progress, to manage participants by viewing lists, removing disruptive users, or adjusting participant settings, and to export session data or generate reports following session completion. The Host Console Device 202 may communicate with the computing system 100 via the Network 190 using encrypted connections to protect administrative credentials and session management commands.

Heads-Up Display Device 203 may be display devices used to present shared visual information to multiple participants simultaneously in physical venues. In some embodiments, Heads-Up Display Device 203 may be large-screen televisions mounted in entertainment venues, conference rooms, or public spaces; projection systems displaying content on screens or walls for audience viewing; or digital signage displays positioned for visibility by groups of participants. The Heads-Up Display Device 203 may execute web browsers in kiosk mode, dedicated display applications, or casting receivers such as Chromecast or AirPlay endpoints that receive display content from the computing system 100. The Heads-Up Display Device 203 may display machine-readable codes generated by the Onboarding Module 230 prominently for scanning by participants during onboarding; shared game boards, question prompts, or instructions that all participants need to see; scoreboards showing participant rankings, team standings, or game progress visible to all participants; and animations, visual effects, or celebration sequences that enhance the viewing experience. The Heads-Up Display Device 203 may communicate with the computing system 100 via the Network 190 to receive interface update messages containing content to display.

Controller Devices 204 may be personal computing devices used by individual participants to interact with application sessions. In some embodiments, Controller Devices 204 may be smartphones carried by participants that provide convenient personal interfaces accessible from anywhere; tablet devices offering larger touch screens for enhanced interaction; laptop computers enabling participation from workstations; or specialized gaming controllers with button inputs and displays. The Controller Devices 204 may execute web browsers navigating to network endpoints encoded in machine-readable codes, dedicated mobile applications installed on the devices that provide native user interfaces and enhanced performance, or progressive web applications (PWAs) that combine web technology with app-like capabilities. Participants may interact with Controller Devices 204 to scan machine-readable codes displayed on Heads-Up Display Device 203 using camera functions or barcode scanning features, initiating automatic connection to application sessions; to enter display names, select preferences, or provide other information during registration processes; to submit inputs such as answers to questions, game actions, or responses to prompts through touch interfaces or text entry; to view participant-specific information such as personal scores, inventory contents, status indicators, or private messages; and to communicate with other participants through in-session chat features or messaging functions. The Controller Devices 204 may communicate with the computing system 100 via the Network 190 using mobile cellular data connections or Wi-Fi connections available in venues or locations where participants use the devices.

Application Engine Instance 205 may represent the runtime execution environment where application-specific logic executes for sessions requiring server-side processing. In some embodiments, Application Engine Instance 205 may be a containerized process executing within an isolated execution environment created by the Engine Instantiation Module 240, a virtual machine instance providing dedicated computational resources for the application session, or a process running within a runtime environment such as Node.js, .NET, or Java Virtual Machine. The Application Engine Instance 205 may execute application-specific logic loaded from the Data Repository 280, processing messages received from client devices via the Central Communication Router 210, applying game rules, quiz logic, or other application-specific algorithms, maintaining application state variables tracking game progress and participant data, generating response messages containing results of processing operations, and transmitting messages to client devices through the Central Communication Router 210. The Application Engine Instance 205 may be created, suspended, and restored by the Engine Instantiation Module 240 and Lifecycle Management Module 250 as described previously, enabling dynamic resource management while preserving session continuity.

In some embodiments, the application program 200 may be implemented using specific technology stacks that enable the game-agnostic architecture while providing dynamic runtime flexibility. The preferred embodiment utilizes .NET as the primary server-side framework, enabling robust type safety, high-performance execution, and extensive library support. Within this .NET environment, the Communication and User Interface Module 265 may implement SignalR to manage real-time WebSocket-style connections between client devices and the server. SignalR provides automatic connection management, fallback transport mechanisms when WebSocket connections are unavailable, and built-in support for broadcasting messages to client groups, making it particularly suitable for coordinating multiple concurrent application sessions where messages must be routed to specific subsets of connected devices based on session identifiers and client roles.

A particularly novel aspect of the implementation involves the Engine Instantiation Module 240 integrating Jint, a JavaScript engine for .NET, to dynamically host and execute JavaScript-based application logic within isolated containers. In some embodiments, Jint enables the system to load JavaScript code files from the Data Repository 280 at runtime, compile them into executable bytecode, and execute them within the .NET process space without requiring separate runtime environments or additional process overhead. This integration allows application-specific logic to be written in JavaScript while the core platform infrastructure operates in .NET, combining the flexibility and rapid development characteristics of JavaScript with the performance and reliability of .NET. The Jint engine provides isolated execution contexts for each engine instance, preventing JavaScript code in one session from accessing variables, functions, or objects belonging to other sessions. When the Lifecycle Management Module 250 suspends engine instances, the serialization process captures the complete state of the Jint execution context including all JavaScript variables, object properties, function closures, and prototype chains, enabling exact state restoration when sessions resume. Developers can modify or replace application-specific JavaScript logic by simply updating files in the Data Repository 280, with changes taking effect for newly created sessions without requiring server restarts or redeployment of the core platform code. This dynamic loading capability dramatically reduces deployment complexity and enables rapid iteration during application development.

In some embodiments utilizing Hypertext Markup Language (HTML) and JavaScript (JS) implementations, the platform may provide a client-side JavaScript framework that executes on client devices to standardize communication between local application logic and the server-side multi-session platform. The client-side framework may be loaded by each client device regardless of assigned client role, executing within web browsers or application runtime environments on Host Console Device 202, Heads-Up Display Device 203, and Controller Devices 204. The framework may locally track the session identifier for the application session on the client device, storing the identifier in memory variables that persist throughout the session duration and providing automatic inclusion of the session identifier in all outgoing messages to eliminate the need for application-specific logic to manually attach session identifiers to each communication.

The client-side framework may expose standardized communication functions that application-specific logic executing on client devices can invoke to transmit messages through the Communication and User Interface Module 265. In some embodiments, the framework may provide broadcastToEngine functions that transmit messages to the Application Engine Instance 205 for server-side processing, broadcastToHost functions that transmit messages to devices assigned the host console role, broadcastToPlayers functions that transmit messages to all devices assigned the controller role within the session, and broadcastToPlayer functions that transmit messages to specific individual controller devices identified by device identifiers passed as function parameters. The framework may implement reconnection management logic that detects network interruptions by monitoring connection state events, automatically attempts to re-establish connections to the server when connectivity is restored by initiating new connection requests containing the stored session identifier, and queues priority messages during disconnection periods by storing them in local memory structures with priority indicators. When connectivity is restored, the framework may transmit queued messages in priority order to ensure critical communications reach the server despite temporary network disruptions.

The client-side framework may also provide client devices with access to the Shared Service Layer 260 capabilities by exposing local function interfaces that internally generate service request messages transmitted to the server. In some embodiments, client-side application logic may invoke framework functions to request artificial intelligence features, globalization formatting, localization translations, or authentication operations, with the framework constructing properly formatted service requests containing necessary parameters and transmitting them to the Shared Service Layer 260 via the Communication and User Interface Module 265. This client-side abstraction layer enables developers creating HTML and JavaScript-based applications to focus on role-specific game logic without implementing low-level communication protocols, session identifier management, reconnection handling, or service integration, as these capabilities are provided automatically by the client-side framework.

The multi-session platform incorporates several built-in capabilities that all hosted applications automatically inherit without requiring separate integration efforts. In some embodiments, the Shared Service Layer 260 provides a lead collection system that enables host users to capture participant contact information during sessions, storing lead data in the Data Repository 280 indexed by session identifiers and host user identifiers for subsequent marketing and engagement activities. The platform includes dynamic photo sharing functionality that allows participants to upload images from Controller Devices 204 during sessions, with uploaded images displayed on Heads-Up Display Device 203 for audience viewing and optionally posted directly to social media platforms through integrations with social media APIs. The globalization and localization capabilities support twelve (12) supported languages including English, Spanish, French, German, Italian, Portuguese, Dutch, Russian, Japanese, Chinese, Korean, and Arabic, with the Shared Service Layer 260 automatically translating application content, interface text, and dynamic messages based on language preferences selected during participant onboarding. These platform-wide features require no additional development work from application creators, demonstrating the extensibility and rapid development advantages of the unified architecture.

The system's versatility has been demonstrated through successful deployment across both gaming and non-gaming applications. In some embodiments, the same multi-session architecture that hosts multiplayer games has been adapted for a DJ queue and music request management system currently in live operational use, wherein participants scan QR codes to join sessions, submit song requests through controller interfaces, and view the request queue on heads-up displays, with the host console providing DJ controls for managing the queue and approving requests. This adaptation required only development of the queue management logic and music database integration, while automatically inheriting the platform's onboarding, authentication, communication, and session management capabilities. The rapid development enabled by the platform has been evidenced by concrete implementation timelines: a Music Bingo application—now a primary product for multiple commercial vendors—was developed by a single developer in approximately one week; the DJ Queue and Music Request system was developed in one day; and a full AI-driven Trivia system was developed in approximately two months. These development timelines represent order-of-magnitude improvements over traditional approaches that would require months or years of development for each application when building separate backend infrastructures.

Alternative implementations of the platform may utilize different technology stacks while maintaining the same functional architecture. In some embodiments, the server-side implementation could use Node.js instead of .NET, with the JavaScript-based application logic executing directly in the Node.js runtime without requiring Jint integration. The WebSocket communication layer could be implemented using Socket. io instead of SignalR, or could use alternative real-time protocols such as WebRTC for peer-assisted communication, gRPC for high-performance remote procedure calls, Message Queuing Telemetry Transport (MQTT) for lightweight publish-subscribe messaging, or raw Transmission Control Protocol (TCP) or User Datagram Protocol (UDP) connections for maximum control over network communication. The containerized engine instances could operate under Docker container orchestration, Kubernetes cluster management, or could be replaced entirely with virtual machines providing stronger isolation guarantees, or with serverless compute services such as Amazon Web Services (AWS) Lambda, Microsoft Azure Functions, or Google Cloud Run that instantiate function execution environments on-demand based on incoming requests. The QR code onboarding mechanism could be replaced with Near Field Communication (NFC) tags that participants tap with their devices, short-link URLs that participants type into browsers, numeric session Personal Identification Number (PIN) codes that participants enter through input forms, or deep links that open native applications directly to session registration interfaces. While the preferred embodiment uses .NET, SignalR, and Jint to achieve the described functionality, these alternative implementations would provide equivalent capabilities for coordinating multiple concurrent application sessions under unified communication frameworks.

The platform's applicability extends beyond multiplayer gaming to encompass any interactive scenario requiring coordination of multiple participants through distinct client roles. In some embodiments, the architecture could be adapted for restaurant menu and ordering systems wherein tables scan QR codes to access menus on controller devices, submit orders that appear on kitchen display systems through heads-up display roles, and receive order status updates in real-time. Educational applications could use the platform for interactive classroom experiences wherein students join lessons through QR code scanning, submit answers to questions through controller interfaces, and view aggregate class results on shared displays. Live polling and audience response systems could leverage the platform for conferences or events wherein attendees join sessions, submit votes or questions, and view real-time polling results. Real-time collaboration environments for remote teams could use the platform to coordinate shared workspaces, document editing, and video conferencing under the same session management and role-based coordination model. Each adaptation leverages the same underlying Central Communication Router 210, Session Management Module 220, Onboarding Module 230, and unified infrastructure while implementing application-specific logic appropriate to the use case.

In some embodiments, the computing system 100 may comprise a plurality of servers distributed across a network to provide scalable infrastructure for the multi-session platform. The Central Communication Router 210 may be configured to distribute the plurality of application sessions across the plurality of servers to balance resource utilization by monitoring computational load metrics including Central Processing Unit (CPU) usage, Random Access Memory (RAM) consumption, network bandwidth utilization, and active session counts for each server in the distributed infrastructure. When a new application session is created, the Session Management Module 220 may select a target server for hosting the session by querying current load metrics from all available servers and identifying servers with available capacity based on configured threshold values. The Central Communication Router 210 may implement load balancing algorithms including round-robin distribution that assigns sessions sequentially across servers, least-connections distribution that assigns sessions to servers with fewest active sessions, weighted distribution that assigns sessions based on relative server capacities, or dynamic distribution that considers real-time performance metrics to optimize resource allocation. In some embodiments, the session identifier registry maintained by the Session Management Module 220 may include server location information indicating which server in the distributed infrastructure hosts each application session, enabling the Central Communication Router 210 to route messages to the correct server for processing. The Engine State Storage 285 may be implemented as a distributed storage system accessible to all servers in the infrastructure, enabling engine instances suspended on one server to be restored on different servers when sessions are reactivated, providing fault tolerance and enabling seamless migration of sessions between servers for maintenance operations or capacity rebalancing. This distributed architecture enables horizontal scaling wherein additional servers can be added to the infrastructure to increase platform capacity, with newly added servers automatically participating in load balancing algorithms without requiring reconfiguration of existing servers or disruption to active application sessions.

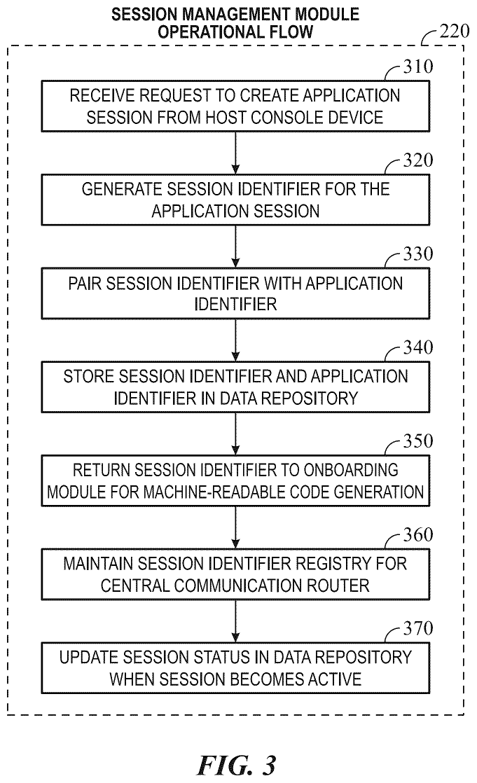

FIG. 3 is a flow diagram illustrating an exemplary operational sequence of the Session Management Module 220 in accordance with certain embodiments. The sequence shown may be implemented as computer-executable instructions within the application program 200 operating on computing system 100 of FIG. 2, with specific operations performed by the modules depicted therein.

At step 310, a request to create an application session is received from a host console device. This operation may be performed by the Session Management Module 220 in coordination with the Communication and User Interface Module 265 of FIG. 2. In some embodiments, host users may submit session creation requests through administrative interfaces displayed on Host Console Device 202 by selecting an application type from available application catalogs and transmitting Hypertext Transfer Protocol (HTTP) POST requests or WebSocket messages to the server.

The Communication and User Interface Module 265 may receive the submitted request via the Network 190, parse the request payload to extract parameters such as the selected application identifier, and invoke a session creation function exposed by the Session Management Module 220 by passing the extracted application identifier as a function parameter.

At step 320, a session identifier is generated for the application session. This operation is performed by the Session Management Module 220, which executes identifier generation algorithms to produce alphanumeric codes or UUID values with extremely low collision probability. In some embodiments, the Session Management Module 220 may generate the session identifier by invoking library functions such as uuid.v4( ) in JavaScript implementations, Guid.NewGuid( ) in .NET implementations, or UUID.randomUUID( ) in Java implementations that produce version 4 UUIDs based on cryptographically secure random number generators.

Alternatively, the module may apply hash functions such as SHA-256 to concatenated strings containing current timestamps retrieved from system clocks and server identity values retrieved from configuration data, then encode the resulting hash output as base64 or hexadecimal strings. The generated session identifier uniquely distinguishes this application session from all other concurrent sessions operating on the multi-session platform.

At step 330, the session identifier is paired with the application identifier. This operation is performed by the Session Management Module 220, which creates associations between the generated session identifier and the application identifier extracted from the session creation request. In some embodiments, the session identifier corresponds to the application identifier through database associations, wherein the pairing operation involves constructing SQL INSERT statements or Not only SQL (NoSQL) document creation commands that store both identifiers in a single record or document structure.

The Session Management Module 220 may execute these commands through the Database Engine 270 by invoking database client libraries that transmit the commands to database servers and await confirmation responses. This pairing enables subsequent queries that provide only a session identifier to retrieve the associated application identifier by executing SQL SELECT statements with WHERE clauses matching the session identifier, or by querying NoSQL collections using session identifier as the lookup key, allowing the Central Communication Router 210 to determine correct application sessions for message routing without examining message content.

At step 340, the session identifier and application identifier are stored in the data repository. This operation is performed by the Session Management Module 220 in coordination with the Database Engine 270. The storage operation creates session registry records containing the session identifier as a primary key field, the application identifier as a foreign key or reference field, host user identifier extracted from authentication context, session creation timestamp generated by invoking time functions such as Date.now( ) or DateTime.UtcNow, and session status indicators initialized to values such as “pending” or “created”.

In some embodiments, the Session Management Module 220 may also populate in-memory hash maps or dictionary data structures indexed by session identifier, storing registry objects that contain application identifiers and status information for rapid lookup operations by the Central Communication Router 210 during message routing without requiring database queries.

At step 350, the session identifier is returned to the onboarding module for machine-readable code generation. This operation is performed by the Session Management Module 220, which transmits the generated session identifier to the Onboarding Module 230 by invoking a callback function provided by the Onboarding Module during initialization, by publishing a session-created event to an event bus or message queue that the Onboarding Module subscribes to, or by directly calling a code generation method exposed by the Onboarding Module and passing the session identifier as a method parameter.

The Onboarding Module 230 receives the session identifier through whichever inter-module communication mechanism is implemented and uses it to produce machine-readable codes that participants can scan to join the application session. In some embodiments, the Session Management Module 220 may also notify the Central Communication Router 210 by invoking a session registration method that adds the new session identifier to active session registries maintained by the router, enabling the router to accept connection requests containing this session identifier.

At step 360, a session identifier registry is maintained for the central communication router. This operation is performed by the Session Management Module 220, which updates registry data structures in response to session lifecycle events. The registry maintenance involves adding entries when new sessions are created by inserting key-value pairs into hash maps where session identifiers serve as keys and session metadata objects serve as values, updating entries when session status changes occur by modifying field values in existing registry objects and optionally persisting changes to the Data Repository 280, and removing entries when sessions are terminated by deleting keys from hash maps and marking database records as inactive.

In some embodiments, the Session Management Module 220 may implement event listeners that respond to connection events published by the Communication and User Interface Module 265, executing registry update operations whenever devices connect or disconnect from sessions.

At step 370, session status is updated in the data repository when the session becomes active. This operation is performed by the Session Management Module 220 when client devices connect to the application session by transmitting connection requests containing the session identifier. The status update modifies session registry records by executing SQL UPDATE statements that set status field values to “active” for records matching the session identifier, or by updating document fields in NoSQL databases.

In some embodiments, the Session Management Module 220 may update additional timestamp fields indicating when the session became active by storing current system time values, enabling subsequent monitoring of session age and activity duration by calculating time differences between current timestamps and stored activation timestamps.

In some embodiments, the operations of steps 310 through 370 occur automatically upon receipt of session creation requests from host console devices, executing as a transaction that ensures all steps complete successfully or roll back to maintain data consistency.

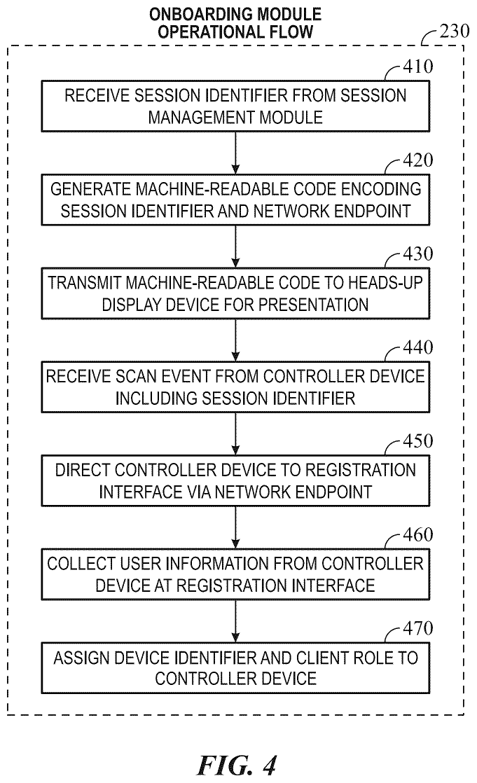

FIG. 4 is a flow diagram illustrating an exemplary operational sequence of the Onboarding Module 230 in accordance with certain embodiments. The sequence shown may be implemented as computer-executable instructions within the application program 200 operating on computing system 100 of FIG. 2, with specific operations performed by the modules depicted therein.

At step 410, a session identifier is received from the session management module. This operation may be performed by the Onboarding Module 230, which receives session identifiers through inter-module communication mechanisms established during application program initialization. In some embodiments, the Onboarding Module 230 may implement callback functions registered with the Session Management Module 220 that are invoked when sessions are created, subscribe to event topics on message buses where the Session Management Module publishes session-created events, or periodically poll shared data structures for new session identifiers.

The received session identifier may be accompanied by the application identifier associated with the session, enabling the Onboarding Module 230 to retrieve application-specific network endpoint configurations from the Data Repository 280 by querying for configuration records matching the application identifier.

At step 420, a machine-readable code encoding the session identifier and network endpoint is generated. This operation is performed by the Onboarding Module 230, which constructs network endpoints by concatenating base URL strings retrieved from server configuration with path segments or query parameters containing the session identifier. In some embodiments, the Onboarding Module 230 may construct URLs such as “https://game.example.com/join? session=[SESSION_ID]” by using string formatting functions, template literals, or URL builder libraries that safely encode special characters in the session identifier.

The module then invokes QR code generation libraries by calling functions such as qrcode.toDataURL( ) in JavaScript implementations or QRCodeGenerator.GenerateQRCode( ) in .NET implementations, passing the constructed URL as input and receiving image data as output. The QR code generation libraries convert the input string into two-dimensional matrix patterns following International Organization for Standardization/International Electrotechnical Commission (ISO/IEC) 18004 QR code standards, with error correction levels selected as function parameters. The generated machine-readable code serves as a visual embodiment of the session identifier that participants can scan with camera-equipped devices.

At step 430, the machine-readable code is transmitted to a heads-up display device for presentation. This operation is performed by the Onboarding Module 230 in coordination with the Communication and User Interface Module 265. The machine-readable code is formatted as image data in PNG, SVG, or JPEG format with appropriate Multipurpose Internet Mail Extensions (MIME) types such as “image/png” or “image/jpeg”, then packaged into messages addressed to the Heads-Up Display Device 203 by including the device identifier for the heads-up display in message headers or routing parameters.

The Onboarding Module 230 invokes message transmission functions exposed by the Central Communication Router 210, passing the formatted message and destination device identifier as parameters. The Central Communication Router 210 transmits the message through network connections managed by the Communication and User Interface Module 265 via the Network 190 using WebSocket send( ) methods or HTTP response streams. In some embodiments, the heads-up display device receives the transmitted image data, decodes it using image rendering libraries, and presents the code prominently on large screens positioned for easy scanning by participants in physical venues.

At step 440, a scan event is received from a controller device including the session identifier. This operation is performed by the Onboarding Module 230 when participants scan the machine-readable code using Controller Devices 204. When participants activate camera applications or QR code scanning features on their devices and position cameras to capture the displayed code, QR code decoding libraries on the controller devices extract the encoded URL string from the captured image by analyzing the two-dimensional matrix pattern and applying error correction algorithms.

The controller device's operating system or browser then automatically navigates to the extracted URL by initiating HTTP GET requests to the network endpoint. The navigation causes the controller device to transmit connection requests to the server that include the session identifier extracted from the URL query parameters or path segments. In some embodiments, the Onboarding Module 230 receives these connection requests through HTTP request handlers or WebSocket connection event listeners implemented by the Communication and User Interface Module 265, which parse incoming request URLs to extract session identifier values from query parameters and invoke onboarding functions exposed by the Onboarding Module 230.

At step 450, the controller device is directed to a registration interface via the network endpoint. This operation is performed by the Onboarding Module 230, which responds to connection requests by generating HTML documents containing registration forms or by transmitting JSON data that client-side applications render as registration interfaces. The registration interface prompts users to enter display names through text input fields, select avatar images through image galleries or dropdown menus, configure language preferences through language selection dropdowns, or provide other information required before joining the application session.

In some embodiments, the Onboarding Module 230 constructs the registration interface HTML by rendering template files with session-specific data, or by returning JSON responses that single-page applications parse and display. The interface content is transmitted to the controller device through HTTP response bodies or WebSocket messages, where web browsers or native applications render the interface elements for user interaction.

At step 460, user information is collected from the controller device at the registration interface. This operation is performed by the Onboarding Module 230 when users complete registration forms by entering text into input fields and pressing submit buttons. The controller device transmits the entered information as HTTP POST request payloads containing form data encoded as application/x-www-form-urlencoded or application/json formats, or as WebSocket messages containing JSON-serialized user data objects.

The Onboarding Module 230 receives the transmitted data through request handlers implemented by the Communication and User Interface Module 265, parses the received payloads by deserializing JSON strings or extracting form field values, validates that required fields are completed by checking for null or empty values and that values meet format requirements by applying regular expressions or validation functions, and stores participant profile data in the Data Repository 280 by executing INSERT commands through the Database Engine 270 that create records indexed by session identifiers and newly assigned device identifiers.

At step 470, a device identifier and client role are assigned to the controller device. This operation is performed by the Onboarding Module 230, which generates unique device identifiers by invoking the same identifier generation mechanisms used for session identifiers, producing UUID values or random alphanumeric strings that distinguish each device. The client role assignment determines whether the device should be assigned as a host console, heads-up display, or controller by analyzing user agent strings parsed from HTTP headers to identify device types, by evaluating screen dimensions reported through browser APIs, or by processing explicit role selections submitted through registration interfaces.

In some embodiments, the Onboarding Module 230 applies conditional logic that assigns the controller role to devices identified as smartphones or tablets based on user agent patterns, assigns the heads-up display role to devices with large screen dimensions or devices accessing designated display URLs, and assigns the host console role to devices authenticated with administrative credentials. The Onboarding Module 230 communicates assigned device identifiers and client roles to the Central Communication Router 210 by invoking device registration methods that store associations between device identifiers, session identifiers, and client roles in routing tables, enabling the router to direct messages to each client device of a plurality of client devices according to the assigned client role.

In some embodiments, the operations of steps 410 through 470 occur automatically for each participant joining an application session through machine-readable code scanning, executing within seconds to provide seamless onboarding experiences without manual session code entry.

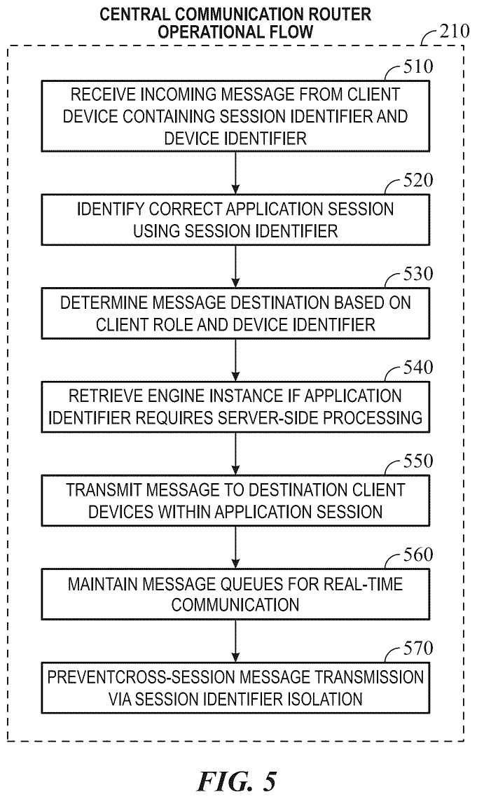

FIG. 5 is a flow diagram illustrating an exemplary operational sequence of the Central Communication Router 210 in accordance with certain embodiments. The sequence shown may be implemented as computer-executable instructions within the application program 200 operating on computing system 100 of FIG. 2, with specific operations performed by the modules depicted therein.

At step 510, an incoming message is received from a client device containing a session identifier and device identifier. This operation may be performed by the Central Communication Router 210 in coordination with the Communication and User Interface Module 265. In some embodiments, client devices transmit messages as JSON-encoded payloads over WebSocket connections or as HTTP POST request bodies, wherein each message includes a session identifier field identifying which application session the message belongs to and a device identifier field identifying which client device sent the message.

The Communication and User Interface Module 265 receives the transmitted messages through network connections established during device onboarding and forwards them to the Central Communication Router 210 by invoking message processing functions or by adding messages to input queues that the router monitors. The Central Communication Router 210 extracts the session identifier and device identifier from message headers, metadata fields, or structured message properties by parsing the message payload using JSON deserialization or by accessing predefined message structure fields.

At step 520, the correct application session is identified using the session identifier. This operation is performed by the Central Communication Router 210, which queries session registries to determine which application session corresponds to the extracted session identifier. In some embodiments, the Central Communication Router 210 retrieves session metadata from in-memory hash maps maintained by the Session Management Module 220 by using the session identifier as a lookup key, accessing mapped values that contain the corresponding application identifier, connected device lists, and session status indicators.

The lookup operation executes in constant time complexity when implemented using hash-based data structures, enabling rapid identification of correct application sessions without examining message content. If the session identifier does not match any active session in the registry, the Central Communication Router 210 may reject the message by returning error responses to the sending device or by quarantining the message for administrative review.

At step 530, the message destination is determined based on client role and device identifier. This operation is performed by the Central Communication Router 210, which evaluates routing rules to identify which client devices should receive the message. In some embodiments, the Central Communication Router 210 retrieves the client role assigned to the sending device from device registration records stored during onboarding, then applies role-based routing logic that determines message destinations according to message type indicators included in message metadata.

For broadcast messages intended for all participants, the router may retrieve all device identifiers associated with the session identifier from connection registries. For role-specific messages, the router filters destination lists to include only devices whose assigned client roles match authorized recipient roles for the message type. For targeted messages addressed to specific devices, the router validates that the target device identifier belongs to the same session identifier as the sending device to prevent cross-session message transmission.

At step 540, an engine instance is retrieved if the application identifier requires server-side processing. This operation is performed by the Central Communication Router 210, which determines whether the application identifier associated with the session requires message processing by application-specific logic. In some embodiments, the Central Communication Router 210 queries application configuration metadata stored in the Data Repository 280 that indicates which application identifiers require engine instances for server-side processing.

When server-side processing is required, the router retrieves the engine instance reference associated with the session identifier from engine instance registries maintained by the Engine Instantiation Module 240. The router then transmits the message to the engine instance by invoking message handler functions exposed through inter-process communication interfaces, passing the message payload as input and receiving processed response messages as output. When server-side processing is not required, the router proceeds directly to transmitting messages between client devices without involving engine instances.

At step 550, the message is transmitted to destination client devices within the application session. This operation is performed by the Central Communication Router 210 in coordination with the Communication and User Interface Module 265. In some embodiments, the router constructs outgoing messages by packaging the original message content or processed response content along with routing metadata such as sender device identifier, message timestamp, and message type indicators.

The router invokes transmission functions provided by the Communication and User Interface Module 265 for each destination device identifier, passing the constructed message and device-specific network connection handles. The Communication and User Interface Module 265 serializes the message into JSON or other transmission formats, transmits the serialized data through WebSocket connections using send( ) methods or through HTTP responses, and confirms successful transmission by checking for acknowledgment responses or monitoring connection status.

At step 560, message queues are maintained for real-time communication. This operation is performed by the Central Communication Router 210, which manages separate message queues for each application session to buffer messages during transmission. In some embodiments, the router implements First-In-First-Out (FIFO) queues using linked list data structures or circular buffers that preserve message ordering within each session.

When messages arrive faster than they can be transmitted due to network congestion or processing delays, the router adds messages to the appropriate session queue indexed by session identifier. Background processing threads or asynchronous tasks continuously monitor queue contents, dequeuing messages and transmitting them to destinations as network bandwidth becomes available. Queue management ensures that message delivery order is preserved and that temporary network disruptions do not result in message loss.

At step 570, cross-session message transmission is prevented via session identifier isolation. This operation is performed by the Central Communication Router 210, which validates session identifier consistency before transmitting any message. In some embodiments, the router implements validation logic that compares the session identifier embedded in each message against the session identifiers associated with all destination device identifiers by querying device registration records.

The validation executes before message transmission occurs, checking that every destination device belongs to the same session identifier as the message's session identifier. When mismatches are detected, indicating attempts to transmit messages across session boundaries, the router blocks transmission by removing mismatched device identifiers from destination lists, logs security events documenting the attempted cross-session transmission for audit purposes, and optionally generates alerts notifying administrators of potential security issues. This isolation ensures that each application session of the plurality of application sessions operates independently from other application sessions via the session identifier.

In some embodiments, the operations of steps 510 through 570 occur continuously throughout application session lifecycles, processing thousands of messages per second across multiple concurrent sessions while maintaining session isolation and message ordering guarantees.

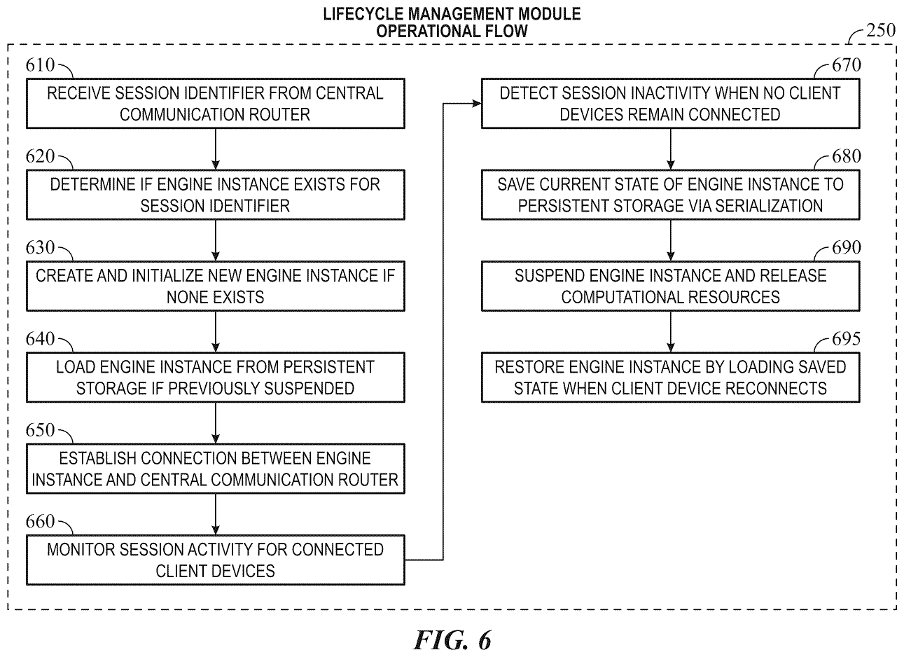

FIG. 6 is a flow diagram illustrating an exemplary operational sequence of the Lifecycle Management Module 250 in accordance with certain embodiments. The sequence shown may be implemented as computer-executable instructions within the application program 200 operating on computing system 100 of FIG. 2, with specific operations performed by the modules depicted therein.

At step 610, a session identifier is received from the central communication router. This operation may be performed by the Lifecycle Management Module 250, which receives session management requests from the Central Communication Router 210 when application sessions require engine instances for server-side processing. In some embodiments, the Central Communication Router 210 invokes lifecycle management functions exposed by the Lifecycle Management Module 250, passing the session identifier and application identifier as parameters, when the router determines that incoming messages or connection events require engine instance availability.

The Lifecycle Management Module 250 receives these invocations through function calls, inter-process communication channels, or message queue subscriptions, extracting the session identifier for use in subsequent engine instance lookup and creation operations.

At step 620, a determination is made whether an engine instance exists for the session identifier. This operation is performed by the Lifecycle Management Module 250, which queries engine instance registries to check if an active or suspended engine instance is associated with the session identifier. In some embodiments, the module searches in-memory registries maintained by the Engine Instantiation Module 240 by using the session identifier as a lookup key to retrieve engine instance references.

If a match is found indicating an active engine instance currently executing, the module proceeds to step 650 to establish connections with the existing instance. If no active instance is found, the module queries the Engine State Storage 285 to determine whether a serialized state exists for the session identifier, indicating a previously suspended engine instance. If serialized state exists, the module proceeds to step 640 to load and restore the engine instance. If neither active instance nor serialized state exists, the module proceeds to step 630 to create a new engine instance.

At step 630, a new engine instance is created and initialized if none exists. This operation is performed by the Lifecycle Management Module 250 in coordination with the Engine Instantiation Module 240. In some embodiments, the Lifecycle Management Module 250 invokes engine creation functions exposed by the Engine Instantiation Module 240, passing the session identifier and application identifier as parameters.

The Engine Instantiation Module 240 executes the creation process as described in FIG. 2, determining the appropriate runtime environment based on the application identifier, creating isolated execution environments such as containerized processes or virtual machines, loading application-specific logic from the Data Repository 280, and initializing the engine instance with session-specific parameters. The Engine Instantiation Module 240 returns an engine instance reference to the Lifecycle Management Module 250, which registers the instance in lifecycle management registries for subsequent monitoring operations.

At step 640, the engine instance is loaded from persistent storage if previously suspended. This operation is performed by the Lifecycle Management Module 250 when serialized state data exists for the session identifier in the Engine State Storage 285. In some embodiments, the module retrieves the serialized state data by querying the Engine State Storage 285 using the session identifier as a lookup key, receiving the complete serialized representation stored during previous suspension operations.

The module then requests the Engine Instantiation Module 240 to create a new engine instance for the session identifier as in step 630, but provides the retrieved serialized state as an additional initialization parameter. The Engine Instantiation Module 240 creates the isolated execution environment and invokes deserialization functions provided by the runtime environment or application-specific logic, passing the serialized state data as input. The deserialization process reconstructs the engine's runtime state by parsing the serialized data format, recreating object instances with stored field values, restoring variable values to their suspended state, and reinitializing execution contexts. This restoration enables the engine instance to resume execution from the suspended point with all application state preserved.

At step 650, a connection is established between the engine instance and the central communication router. This operation is performed by the Lifecycle Management Module 250 in coordination with the Central Communication Router 210. In some embodiments, the Lifecycle Management Module 250 invokes engine registration functions exposed by the Central Communication Router 210, passing the session identifier and engine instance reference as parameters.

The Central Communication Router 210 stores the engine instance reference in message routing tables indexed by session identifier, enabling subsequent messages belonging to that session to be transmitted to the engine instance for processing. The Lifecycle Management Module 250 also configures bidirectional communication channels by subscribing the engine instance to message streams from the router and registering message handlers that receive messages from the router, process them through application-specific logic, and return response messages for transmission to client devices.

At step 660, session activity is monitored for connected client devices. This operation is performed by the Lifecycle Management Module 250, which continuously tracks activity metrics for each engine instance under management. In some embodiments, the module subscribes to connection events published by the Communication and User Interface Module 265, receiving notifications whenever client devices connect or disconnect from application sessions.

The module maintains connection count values for each session identifier, incrementing counts when devices connect and decrementing counts when devices disconnect. The module also records timestamps of recent message transmissions by monitoring message traffic through the Central Communication Router 210 or by receiving activity update events from the router. These activity metrics enable the module to detect inactivity conditions that trigger suspension processes.

In some embodiments, the Lifecycle Management Module 250 may transmit periodic heartbeat messages to active engine instances to enable time-based application logic processing. The heartbeat mechanism may involve transmitting timing information to each Application Engine Instance 205 at regular intervals such as once per second, wherein each heartbeat message contains current tick values representing total elapsed time since session initialization and delta timestamp values representing time elapsed since the previous heartbeat transmission. The engine instances may receive these heartbeat messages and invoke time-dependent processing routines within application-specific logic, enabling applications to update game states, advance timers, trigger scheduled events, or process continuous animations based on the passage of time rather than solely responding reactively to messages from client devices. This heartbeat mechanism enables application logic to implement features such as countdown timers that decrement automatically, automatic progression to next game phases when time limits expire, real-time scoring calculations that account for response speed, or continuous state updates that occur independent of participant actions.

At step 670, session inactivity is detected when no client devices remain connected. This operation is performed by the Lifecycle Management Module 250, which evaluates activity metrics against configured inactivity thresholds. In some embodiments, the module detects inactivity when connection count values for a session identifier reach zero, indicating all client devices have disconnected, or when the elapsed time since the most recent message transmission exceeds a predetermined time period such as 5 minutes, 15 minutes, or other configured durations retrieved from system configuration data.

When inactivity is detected, the module makes a determination whether to suspend the engine instance immediately or to wait for a grace period to accommodate brief disconnections where participants may reconnect shortly. If inactivity persists beyond configured thresholds, the module proceeds to step 680 to suspend the engine instance.

At step 680, the current state of the engine instance is saved to persistent storage via serialization. This operation is performed by the Lifecycle Management Module 250, which initiates state preservation before terminating the engine instance. In some embodiments, the module first notifies the engine instance that suspension is about to occur by invoking pre-suspension callback functions exposed by application-specific logic, allowing the application to execute cleanup routines, flush pending data operations, or reach stable suspension points.

The module then invokes serialization functions provided by the runtime environment or application-specific logic, which convert the engine instance's current state into a serialized format for storage. The serialization process captures all application variables, participant data, temporal information, event queues, and any other runtime state necessary to restore the engine instance. The module stores the resulting serialized data in the Engine State Storage 285 by executing write operations indexed by the session identifier, enabling subsequent retrieval during restoration operations.

At step 690, the engine instance is suspended and computational resources are released. This operation is performed by the Lifecycle Management Module 250, which terminates the engine instance after successfully saving its state. In some embodiments, the module instructs the Engine Instantiation Module 240 to terminate the engine instance by invoking shutdown functions that stop the execution environment, release allocated memory resources by deallocating memory pools and freeing heap allocations, close network connections established by the engine instance, and remove containerized environments or terminate processes.

The termination frees computational resources including Central Processing Unit (CPU) cycles, Random Access Memory (RAM) capacity, and network bandwidth that were allocated to the now-inactive session, enabling those resources to be reallocated to active sessions or other system processes. The Lifecycle Management Module 250 updates engine instance registries to mark the session as suspended and removes the engine instance reference from active instance lists while maintaining the association between the session identifier and the location of saved state data in the Engine State Storage 285.

At step 695, the engine instance is restored by loading the saved state when a client device reconnects. This operation is performed by the Lifecycle Management Module 250 when it receives notifications that client devices have reconnected to suspended sessions. In some embodiments, when the Communication and User Interface Module 265 receives connection requests containing session identifiers associated with suspended engine instances, it notifies the Lifecycle Management Module 250 of the reconnection event.

The module then executes the restoration process described in step 640, retrieving the saved state from the Engine State Storage 285, requesting engine instance creation from the Engine Instantiation Module 240, and providing the serialized state for deserialization during initialization. Once the engine instance is restored and connections are established with the Central Communication Router 210, the module resumes activity monitoring as described in step 660. Participants reconnecting to the session observe that their progress, scores, positions, and other session data remain exactly as they were before disconnection, providing seamless continuity despite the suspension and resource release that occurred during the inactivity period.

In some embodiments, the operations of steps 610 through 695 occur automatically throughout engine instance lifecycles, enabling dynamic resource management that conserves computational resources during periods of inactivity while preserving session states for seamless restoration when activity resumes.

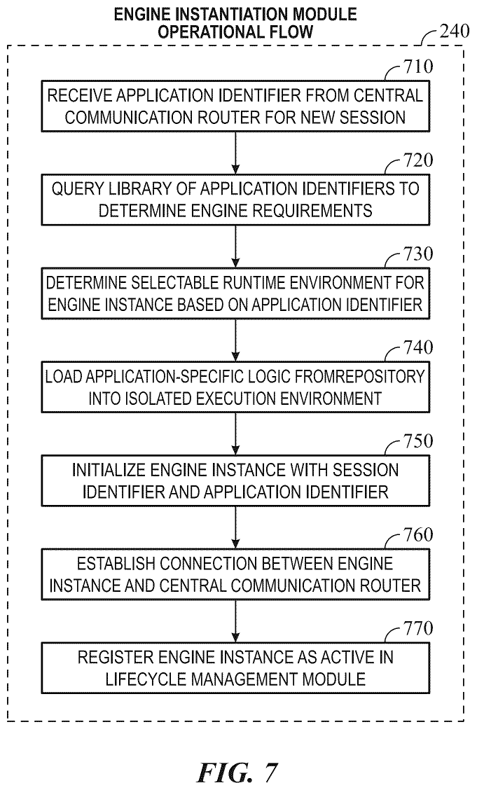

FIG. 7 is a flow diagram illustrating an exemplary operational sequence of the Engine Instantiation Module 240 in accordance with certain embodiments. The sequence shown may be implemented as computer-executable instructions within the application program 200 operating on computing system 100 of FIG. 2, with specific operations performed by the modules depicted therein.

At step 710, an application identifier is received from the central communication router for a new session. This operation may be performed by the Engine Instantiation Module 240 when the Central Communication Router 210 determines that an application session requires server-side processing. In some embodiments, the Central Communication Router 210 invokes engine creation functions exposed by the Engine Instantiation Module 240, passing the session identifier and application identifier as parameters through function calls or inter-process communication channels.

The Engine Instantiation Module 240 receives these parameters and prepares to create an engine instance by extracting the application identifier for use in subsequent configuration retrieval and runtime environment selection operations.

At step 720, a library of application identifiers is queried to determine engine requirements. This operation is performed by the Engine Instantiation Module 240, which retrieves application configuration metadata from the Data Repository 280. In some embodiments, the module executes database queries through the Database Engine 270 using the application identifier as a search key, retrieving configuration records that specify runtime environment requirements, application code file locations, initialization parameters, resource limits, and dependency requirements.

The retrieved metadata indicates which runtime platform the application requires, such as Node.js for JavaScript applications, .NET Common Language Runtime for C# applications, Java Virtual Machine for Java applications, or Python interpreters for Python applications. The metadata may also specify memory allocation limits, processor time quotas, and network bandwidth restrictions that should be enforced for the engine instance.

At step 730, a selectable runtime environment is determined for the engine instance based on the application identifier. This operation is performed by the Engine Instantiation Module 240, which selects the appropriate execution platform from available runtime environments based on the requirements retrieved in step 720. In some embodiments, the module evaluates the runtime specification field in the application configuration metadata and identifies a matching runtime environment from the plurality of available runtime environments installed on the server infrastructure.

The selection process may involve checking runtime environment availability by querying installed software versions, verifying that required dependencies and libraries are available, and determining whether sufficient computational resources exist to instantiate the runtime environment. If multiple versions of a runtime environment are available, the module selects the version specified in the application configuration metadata or defaults to the most recent stable version.

At step 740, application-specific logic is loaded from the repository into an isolated execution environment. This operation is performed by the Engine Instantiation Module 240, which creates isolated execution environments and populates them with application code. In some embodiments, the module creates containerized environments using container technologies such as Docker by invoking container creation APIs that specify base images, resource limits, and network isolation configurations.

The module retrieves application code files from the Data Repository 280 by querying for files associated with the application identifier, receiving file contents or file storage locations as query results. The module copies or mounts these files into the isolated execution environment's filesystem by invoking file system operations that write data to container volumes or isolated directory structures. The module also installs required dependencies by executing package manager commands such as npm install for Node.js applications, dotnet restore for .NET applications, or pip install for Python applications within the isolated environment.

At step 750, the engine instance is initialized with the session identifier and application identifier. This operation is performed by the Engine Instantiation Module 240, which launches the application-specific logic within the isolated execution environment. In some embodiments, the module executes startup commands specified in application configuration metadata, such as “node app.js” for Node.js applications or “dotnet run” for .NET applications, passing the session identifier and application identifier as command-line arguments or environment variables.

The initialization process may invoke application-specific initialization functions that load configuration data, establish database connections, initialize data structures, and prepare the application to begin processing messages. The module monitors the initialization process by capturing standard output and error streams, checking for successful startup indicators, and detecting initialization errors that would prevent the engine instance from functioning properly.

At step 760, a connection is established between the engine instance and the central communication router. This operation is performed by the Engine Instantiation Module 240 in coordination with the Central Communication Router 210. In some embodiments, the module configures inter-process communication channels by creating network socket connections between the engine instance and the router, establishing message queues that enable asynchronous message passing, or exposing API endpoints within the engine instance that the router can invoke to transmit messages.

The module registers the engine instance with the Central Communication Router 210 by invoking registration functions that store the engine instance reference in routing tables indexed by session identifier, enabling the router to direct messages belonging to that session to the engine instance for processing. The connection establishment may include authentication procedures where the engine instance proves its identity by providing tokens or credentials, and capability negotiation where the engine instance advertises which message types it can process.

At step 770, the engine instance is registered as active in the lifecycle management module. This operation is performed by the Engine Instantiation Module 240, which notifies the Lifecycle Management Module 250 that a new engine instance has been created and is ready for monitoring. In some embodiments, the module invokes registration functions exposed by the Lifecycle Management Module 250, passing the session identifier, engine instance reference, and initialization timestamp as parameters.

The Lifecycle Management Module 250 adds the engine instance to lifecycle management registries by creating registry entries that associate the session identifier with the engine instance reference, enabling subsequent monitoring operations as described in FIG. 6. The registration enables the Lifecycle Management Module 250 to track session activity, detect inactivity conditions, and execute suspension processes when appropriate.

In some embodiments, the operations of steps 710 through 770 occur automatically when the Central Communication Router 210 determines that application sessions require engine instances, completing within seconds to enable rapid initialization of server-side processing capabilities for interactive applications.

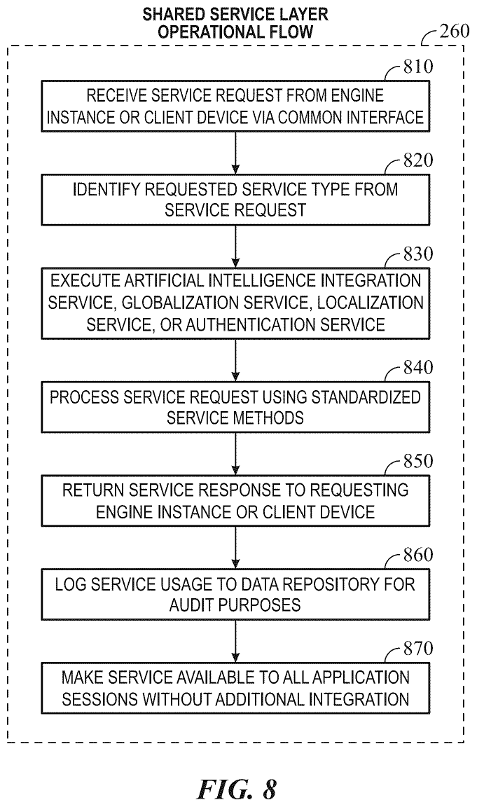

FIG. 8 is a flow diagram illustrating an exemplary operational sequence of the Shared Service Layer 260 in accordance with certain embodiments. The sequence shown may be implemented as computer-executable instructions within the application program 200 operating on computing system 100 of FIG. 2, with specific operations performed by the modules depicted therein.

At step 810, a service request is received from an engine instance or client device via a common interface. This operation may be performed by the Shared Service Layer 260, which exposes API functions that application-specific logic executing within engine instances can invoke to access shared capabilities. In some embodiments, engine instances invoke service functions by making HTTP POST requests to API endpoints hosted by the Shared Service Layer 260, by calling remote procedure call (RPC) methods through inter-process communication channels, or by publishing service request messages to message queues that the Shared Service Layer subscribes to.

The service request includes parameters specifying which standardized capability is needed, such as artificial intelligence integration, globalization functionality, localization functionality, or authentication services, along with input data that the service should process. The Shared Service Layer 260 receives these requests through request handler functions that parse request payloads, extract service type indicators and input parameters, and prepare to execute the requested service.

At step 820, the requested service type is identified from the service request. This operation is performed by the Shared Service Layer 260, which examines service request parameters to determine which standardized capability should be invoked. In some embodiments, the service request includes a service type field containing enumerated values such as “AI_CONTENT_GENERATION”, “TRANSLATE_TEXT”, “FORMAT_CURRENCY”, or “AUTHENTICATE_USER” that explicitly indicate the requested service.

The Shared Service Layer 260 extracts this service type indicator by parsing JSON request payloads, examining HTTP request path components, or reading message header fields. The module uses the service type to select which service implementation function should process the request, routing the request to the appropriate internal service component through conditional logic or service registry lookups.

At step 830, artificial intelligence integration, globalization, localization, or authentication service is executed. This operation is performed by the Shared Service Layer 260, which invokes the appropriate service implementation based on the service type identified in step 820. In some embodiments, when artificial intelligence integration is requested, the module may invoke machine learning model inference functions by passing input data to trained models loaded in memory or by submitting inference requests to external AI service providers through API calls.

For natural language processing tasks, the module may apply sentiment analysis algorithms, entity extraction functions, or text classification models to analyze participant messages. For content generation tasks, the module may invoke language models that produce dynamic questions, story narratives, or personalized recommendations based on generation parameters provided in the service request.

When globalization functionality is requested, the module executes formatting functions that adapt content to regional requirements. For currency conversion, the module retrieves current exchange rates from cached rate data or external financial data providers and applies conversion calculations to transform amounts from source currencies to target currencies. For date and time formatting, the module applies locale-specific formatting rules retrieved from internationalization libraries that format temporal values according to regional conventions.

When localization functionality is requested, the module executes translation operations by retrieving translated message strings from translation databases indexed by message identifiers and language codes. In some embodiments, the module queries the Data Repository 280 for translation records where the message identifier and target language code match the service request parameters, receiving translated text as query results. For user-generated content requiring translation, the module may invoke machine translation APIs provided by external translation services or apply neural machine translation models to generate translations.

When authentication services are requested, the module executes identity verification operations by comparing provided credentials against stored authentication data. For username and password authentication, the module retrieves hashed password values from user account records stored in the Data Repository 280 and applies password verification functions such as bcrypt.compare( ) or Argon2 verification functions that securely compare provided passwords against stored hashes without exposing the original passwords. For token-based authentication, the module validates JSON Web Tokens (JWT) by verifying digital signatures, checking expiration timestamps, and extracting user identity claims from token payloads.

At step 840, the service request is processed using standardized service methods. This operation is performed by the Shared Service Layer 260, which applies consistent processing logic across all service requests regardless of which application session made the request. In some embodiments, the standardized processing includes input validation that checks whether required parameters are present and whether parameter values meet format and range requirements, error handling that catches exceptions during service execution and generates appropriate error responses, logging that records service invocation events including timestamps and requesting application identifiers for audit purposes, and rate limiting that enforces usage quotas to prevent individual applications from exhausting shared service capacity.

The standardized methods ensure consistent behavior across all application sessions accessing shared capabilities, enabling applications to rely on predictable service responses and error handling behavior.

At step 850, the service response is returned to the requesting engine instance or client device. This operation is performed by the Shared Service Layer 260, which packages service execution results into response messages. In some embodiments, the module constructs response payloads containing the service output data, such as generated content from AI services, translated text from localization services, formatted values from globalization services, or authentication verification results from authentication services.

The module transmits the response to the requesting entity using the same communication channel through which the request was received, such as HTTP response bodies for API requests, RPC response messages for remote procedure calls, or response messages published to message queues. The response includes status indicators that inform the requester whether the service execution succeeded or failed, and if failed, what error condition occurred.

At step 860, service usage is logged to the data repository for audit purposes. This operation is performed by the Shared Service Layer 260, which generates audit records documenting each service invocation. In some embodiments, the module creates log records containing the session identifier or application identifier of the requesting entity, the service type that was invoked, the timestamp when the service was executed, the input parameters provided in the service request, the service execution duration measured in milliseconds, and the response status indicating success or failure.

The module stores these log records in the Data Repository 280 by executing INSERT commands through the Database Engine 270, creating persistent audit trails that enable usage analysis, billing calculations based on service consumption, and security monitoring that detects anomalous service usage patterns.

At step 870, the service is made available to all application sessions without additional integration. This operation represents the ongoing availability of standardized capabilities rather than a discrete action performed during service invocation. In some embodiments, the Shared Service Layer 260 maintains continuous availability by keeping service implementation functions loaded in memory, maintaining active connections to external service providers, and monitoring service health to detect failures.

New applications deployed on the multi-session platform automatically inherit access to all standardized capabilities provided by the Shared Service Layer 260 without requiring developers to implement separate integrations for artificial intelligence functionality, translation capabilities, authentication mechanisms, or globalization features. This automatic inheritance reduces development time and ensures consistent capability availability across all hosted applications.

In some embodiments, the operations of steps 810 through 870 occur continuously as engine instances and client devices invoke shared services, processing thousands of service requests per second across multiple concurrent application sessions while maintaining consistent service quality and performance.

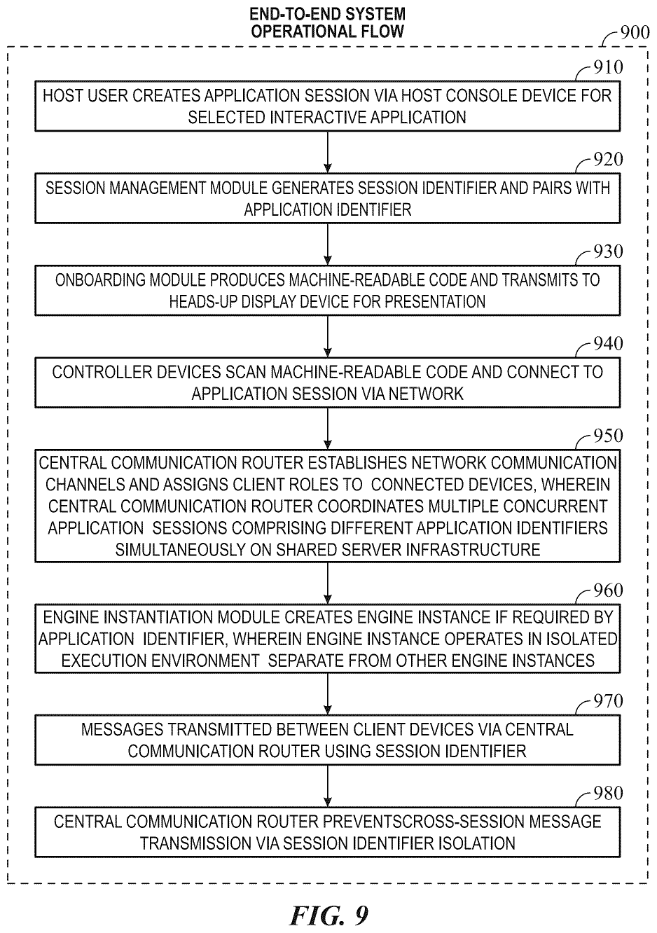

FIG. 9 is a flow diagram illustrating an exemplary end-to-end system operational flow in accordance with certain embodiments. The sequence shown may be implemented as computer-executable instructions within the application program 200 operating on computing system 100 of FIG. 2, demonstrating the integrated operation of multiple modules to coordinate interactive application sessions from creation through active operation.

At step 910, a host user creates an application session via a host console device for a selected interactive application. This operation may be performed by a host user interacting with Host Console Device 202 to request session creation for a specific application type. In some embodiments, the host user navigates to session creation interfaces displayed in web browsers or host applications, browses available application catalogs showing supported interactive applications such as trivia games, bingo games, or quiz competitions, selects a desired application type by clicking on application entries or submitting selection forms, and transmits the session creation request to the server by invoking HTTP POST requests that include the selected application identifier.

The Communication and User Interface Module 265 receives the request and invokes the Session Management Module 220 to begin the session creation process as described in FIG. 3.

At step 920, the session management module generates a session identifier and pairs it with the application identifier. This operation is performed by the Session Management Module 220 as described in steps 320 and 330 of FIG. 3. In some embodiments, the module executes identifier generation algorithms to produce a globally unique session identifier using UUID generation functions or cryptographic hash functions applied to timestamp and server identity combinations.

The module creates associations between the generated session identifier and the application identifier by storing both identifiers in session registry records in the Data Repository 280, enabling the session identifier to correspond to the application identifier through database relationships. This pairing enables all subsequent operations to determine which type of interactive application is associated with each session by querying registries using session identifiers as lookup keys.

At step 930, the onboarding module produces a machine-readable code and transmits it to a heads-up display device for presentation. This operation is performed by the Onboarding Module 230 as described in FIG. 4. In some embodiments, the module receives the session identifier from the Session Management Module 220, constructs network endpoints by concatenating base URLs with the session identifier as query parameters, invokes QR code generation libraries to encode the network endpoint into two-dimensional matrix barcodes, and transmits the generated QR code image to the Heads-Up Display Device 203 via the Central Communication Router 210 and Network 190.

The heads-up display device presents the machine-readable code prominently on large screens positioned in physical venues where participants can easily scan the code with their controller devices.

At step 940, controller devices scan the machine-readable code and connect to the application session via the network. This operation is performed by participants using Controller Devices 204 to join the application session. In some embodiments, participants activate camera applications or QR code scanning features on smartphones or tablets, position device cameras to capture the displayed machine-readable code, allow QR code decoding libraries to extract the encoded network endpoint from the captured image, and automatically navigate to the extracted URL as the device's operating system initiates HTTP GET requests to the server.

The controller devices transmit connection requests containing the session identifier extracted from the URL parameters, and the Onboarding Module 230 directs devices to registration interfaces where users enter display names and preferences as described in FIG. 4. Upon completing registration, the Onboarding Module 230 assigns device identifiers and client roles to each connecting device.

At step 950, the central communication router establishes network communication channels and assigns client roles to connected devices, coordinating multiple concurrent application sessions comprising different application identifiers simultaneously on shared server infrastructure. This operation is performed by the Central Communication Router 210 in coordination with the Communication and User Interface Module 265. In some embodiments, the Communication Module establishes persistent bidirectional communication channels using WebSocket connections that maintain continuous connectivity between the server and each client device throughout the application session duration.

The Central Communication Router 210 receives client role assignments from the Onboarding Module 230 and stores these assignments in routing tables that associate each device identifier with its assigned client role, session identifier, and network connection handle. The router maintains separate routing contexts for each session identifier, enabling it to coordinate multiple distinct application sessions comprising different application identifiers simultaneously under the unified communication framework. The isolation of routing contexts ensures that messages belonging to one session cannot be transmitted to devices in other sessions, preventing cross-session interference while allowing all sessions to share common routing infrastructure and server resources.

At step 960, the engine instantiation module creates an engine instance if required by the application identifier, wherein the engine instance operates in an isolated execution environment separate from other engine instances. This operation is performed by the Engine Instantiation Module 240 as described in FIG. 7, but only when the application identifier indicates that server-side processing is required. In some embodiments, the Central Communication Router 210 queries application configuration metadata to determine whether the application identifier requires an engine instance.

When required, the Engine Instantiation Module 240 executes the creation process by determining the selectable runtime environment based on the application identifier, creating containerized environments or other isolation mechanisms that provide process-level separation, loading application-specific logic from the Data Repository 280 into the isolated execution environment, initializing the engine instance with the session identifier and application identifier, and establishing connections between the engine instance and the Central Communication Router 210 to enable message routing. The isolated execution environment ensures that the engine instance operates separately from other engine instances serving concurrent application sessions, preventing errors or crashes in one session from affecting other sessions.

At step 970, messages are transmitted between client devices via the central communication router using the session identifier. This operation is performed by the Central Communication Router 210 as described in FIG. 5. In some embodiments, client devices submit inputs by transmitting messages containing session identifiers and device identifiers through WebSocket connections or HTTP POST requests. The Central Communication Router 210 receives these messages, identifies the correct application session by looking up the session identifier in session registries, determines message destinations based on client roles and message type indicators, and transmits messages to destination devices.

When engine instances exist for server-side processing, the router transmits messages to engine instances for processing, receives response messages containing computed results or game state updates, and routes these responses back to appropriate client devices. Host console devices receive administrative status updates, heads-up display devices receive shared visual content for audience viewing, and controller devices receive participant-specific information and feedback.

At step 980, the central communication router prevents cross-session message transmission via session identifier isolation. This operation is performed by the Central Communication Router 210 as described in step 570 of FIG. 5. In some embodiments, the router implements validation logic that executes before every message transmission, comparing the session identifier embedded in each message against the session identifiers associated with all destination device identifiers.

When the router detects mismatches indicating attempts to transmit messages across session boundaries, it blocks the transmission by removing mismatched devices from destination lists, logs security events documenting attempted cross-session transmissions, and generates alerts for administrative review. This isolation mechanism ensures that each application session of the plurality of application sessions operates independently from other application sessions via the session identifier, preventing messages from one session from being transmitted to client devices belonging to different sessions and protecting session data from unauthorized access.

In some embodiments, the operations of steps 910 through 980 represent the complete end-to-end workflow for coordinating interactive application sessions on the multi-session platform. The integrated operation enables host users to rapidly deploy application sessions, enables participants to join sessions seamlessly through machine-readable code scanning, enables the platform to coordinate multiple concurrent sessions under unified infrastructure, and ensures session isolation through identifier-based validation. This coordinated workflow may reduce infrastructure costs by consolidating multiple applications onto shared server resources, improve participant experiences through streamlined onboarding and real-time interaction, and enable rapid deployment of new interactive applications without requiring separate backend development.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented session management system for coordinating multiple concurrent interactive applications via a unified communication framework, the system comprising:
at least one computing device in operable communication with a network;
a server in operable communication with the at least one computing device over the network, the server configured to host a multi-session platform comprising:
a central communication router configured to maintain a plurality of application sessions concurrently, wherein each application session of the plurality of application sessions is identified by a session identifier and an application identifier, and wherein the central communication router is further configured to receive messages from client devices and direct the messages to a correct application session via the session identifier and the application identifier, wherein the central communication router determines the correct application session without interpreting content of the messages;
a session management module configured to generate the session identifier for each application session of the plurality of application sessions, wherein the session identifier corresponds to the application identifier;
an onboarding module configured to produce a machine-readable code encoding the session identifier and a network endpoint corresponding to the application identifier, wherein scanning the machine-readable code directs a client device to a registration interface where a user enters information to join the application session;
a plurality of client devices, wherein each client device of the plurality of client devices is configured to connect to the central communication router via a network communication channel, wherein each client device of the plurality of client devices is assigned a client role for the application session, and wherein the central communication router directs messages to each client device of the plurality of client devices according to the assigned client role;
an engine instantiation module configured to create and initialize an engine instance for at least one application session of the plurality of application sessions, wherein the engine instance executes application-specific logic within an isolated execution environment separate from other engine instances;
a lifecycle management module configured to manage the engine instance by suspending the engine instance when session activity indicates inactivity, wherein the lifecycle management module saves a current state of the engine instance to persistent storage when suspending, and restores the engine instance by loading the saved state from the persistent storage when a client device subsequently reconnects to the application session; and
wherein the central communication router is further configured to coordinate multiple distinct application sessions comprising different application identifiers simultaneously under the unified communication framework, wherein each application session of the plurality of application sessions operates independently from other application sessions via the session identifier.

2. The system of claim 1, wherein the client role comprises at least one of a host console configured to manage administrative controls for the application session, a heads-up display configured to present visual information to multiple participants, or a controller configured to receive input from an individual participant.

3. The system of claim 1, wherein the machine-readable code is a Quick Response (QR) code, and wherein the QR code serves as a visual embodiment of the session identifier.

4. The system of claim 1, wherein the network communication channel comprises a real-time bidirectional communication protocol, and wherein the central communication router maintains one or more message queues for each application session of the plurality of application sessions to facilitate real-time communication among all client devices assigned to that application session.

5. The system of claim 1, wherein the engine instantiation module is configured to determine whether the application identifier requires the engine instance, and wherein the central communication router transmits messages directly between client devices for application sessions that do not require the engine instance.

6. The system of claim 4, wherein each client device of the plurality of client devices is assigned a device identifier, and wherein the central communication router uses the device identifier to transmit targeted messages to individual client devices within the application session.

7. The system of claim 1, wherein suspending the engine instance comprises converting the current state of the engine instance into a serialized format for storage, and wherein restoring the engine instance comprises converting the saved state from the serialized format back into an operational state.

8. The system of claim 1, wherein the lifecycle management module is further configured to terminate the engine instance when the lifecycle management module detects that no client devices remain connected to the application session for a predetermined time period.

9. The system of claim 1, wherein the isolated execution environment is a containerized environment, and wherein each engine instance of a plurality of engine instances operates within a separate containerized environment to prevent cross-interference between application sessions.

10. The system of claim 1, wherein the multi-session platform further comprises a shared service layer configured to provide standardized capabilities comprising at least one of artificial intelligence integration, globalization functionality, localization functionality, or authentication services, wherein the standardized capabilities are accessible to all application sessions via a common interface.

11. The system of claim 1, wherein the central communication router is further configured to coordinate application sessions for multiple host users simultaneously, wherein each host user of the multiple host users initiates a separate application session with a distinct session identifier, and wherein the multiple host users operate different interactive applications under the unified communication framework on shared server infrastructure.

12. The system of claim 1, wherein the engine instance comprises a selectable runtime environment configured to execute the application-specific logic, wherein the selectable runtime environment is selected from a plurality of available runtime environments according to a parameter corresponding to the application identifier.

13. The system of claim 1, wherein the central communication router is configured to prevent messages from one application session of the plurality of application sessions from being transmitted to client devices belonging to a different application session of the plurality of application sessions through use of the session identifier.

14. The system of claim 1, wherein the server comprises a plurality of servers distributed across a network, and wherein the central communication router is configured to distribute the plurality of application sessions across the plurality of servers to balance resource utilization.

15. A computer-implemented method, executed by at least one processor of a computing device, for coordinating multiple concurrent interactive applications via a unified communication framework, the method comprising:
receiving, via a server, a request to create an application session for an interactive application;
generating, via the server, a session identifier for the application session, wherein the session identifier corresponds to an application identifier that identifies the interactive application;
producing, via the server, a machine-readable code encoding the session identifier and a network endpoint corresponding to the application identifier;
displaying, via a first client device, the machine-readable code;
receiving, via the server, a connection request from a second client device after the second client device scans the machine-readable code, wherein the connection request includes the session identifier;
assigning, via the server, a client role to the second client device for the application session;
establishing, via the server, a network communication channel between the server and the second client device;
receiving, via the server, messages from client devices connected to the application session;
directing, via the server, the messages to the application session via the session identifier and the application identifier without interpreting content of the messages;
transmitting, via the server, the messages to client devices belonging to the application session according to assigned client roles;
creating and initializing, via the server, an engine instance for the application session when required by the application identifier, wherein the engine instance executes application-specific logic within an isolated execution environment;
suspending, via the server, the engine instance when session activity indicates inactivity, wherein suspending comprises saving a current state of the engine instance to persistent storage; and
restoring, via the server, the engine instance by loading the saved state from the persistent storage when a client device subsequently reconnects to the application session.

16. The method of claim 15, wherein the client role comprises at least one of a host console configured to manage administrative controls for the application session, a heads-up display configured to present visual information to multiple participants, or a controller configured to receive input from an individual participant, and wherein transmitting the messages comprises transmitting different message content to each client device according to the assigned client role.

17. The method of claim 15, further comprising:
maintaining, via the server, a plurality of application sessions concurrently, wherein each application session of the plurality of application sessions is identified by a respective session identifier and a respective application identifier;
coordinating, via the server, multiple distinct application sessions comprising different application identifiers simultaneously under the unified communication framework; and
preventing, via the server, messages from one application session of the plurality of application sessions from being transmitted to client devices belonging to a different application session of the plurality of application sessions through use of the respective session identifier.

18. A software product comprising at least one computer-readable storage medium having application instructions stored on the at least one computer-readable storage medium, the application instructions executable by at least one processor to:
generate a session identifier for an application session of an interactive application, wherein the session identifier corresponds to an application identifier that identifies the interactive application;
produce a machine-readable code encoding the session identifier and a network endpoint corresponding to the application identifier;
receive a connection request from a client device after the client device scans the machine-readable code, wherein the connection request includes the session identifier;
assign a client role to the client device for the application session;
establish a network communication channel between a server and the client device;
receive messages from a plurality of client devices connected to the application session;
direct the messages to the application session via the session identifier and the application identifier without interpreting content of the messages;
transmit the messages to client devices belonging to the application session according to assigned client roles;
create and initialize an engine instance for the application session when required by the application identifier, wherein the engine instance executes application-specific logic within an isolated execution environment;
suspend the engine instance when session activity indicates inactivity, wherein suspending comprises saving a current state of the engine instance to persistent storage; and
restore the engine instance by loading the saved state from the persistent storage when a client device subsequently reconnects to the application session.

19. The software product of claim 18, wherein the application instructions are further executable to:
maintain a plurality of application sessions concurrently, wherein each application session of the plurality of application sessions is identified by a respective session identifier and a respective application identifier; and
coordinate multiple distinct application sessions comprising different application identifiers simultaneously under a unified communication framework, wherein each application session of the plurality of application sessions operates independently from other application sessions via the respective session identifier.

20. The software product of claim 19, wherein the application instructions are further executable to provide a shared service layer comprising standardized capabilities accessible to all application sessions via a common interface, wherein the standardized capabilities comprise at least one of artificial intelligence integration, globalization functionality, localization functionality, or authentication services, and wherein each application session of the plurality of application sessions automatically inherits the standardized capabilities without requiring additional integration.
